(19) United States
(12) Patent Application Publication
(10) Pub. No.: US 2025/0141396 A1
(43) Pub. Date: May 1, 2025

(54) Height Adjustment Roof Mounting System

(71) Applicant: Enstall US, Inc., Walnut Creek, CA (US)

(72) Inventors: Aaron Williamson, Laveen, AZ (US); Jon Ash, Phoenix, AZ (US); John Bullen, Mesa, AZ (US); Brian Fernando, Avondale, AZ (US); John Hudson, Walnut Creek, CA (US); Taylor Ray, Doraville, CA (US); Roger Pedlar, Phoenix, AZ (US)

(21) Appl. No.: 18/935,190

(22) Filed: Nov. 1, 2024

Related U.S. Application Data
(60) Provisional application No. 63/595,263, filed on Nov. 1, 2023.
(60) Provisional application No. 63/673,660, filed on Jul. 19, 2024.

(51) Int. Cl. H02S 20/23

(52) U.S. Cl. CPC H02S 20/23

(57) ABSTRACT

A roof mount includes a base, an adjustment assembly operatively coupled to the base, the adjustment assembly including a partially threaded shaft extending along an axis substantially perpendicular to the roof, an adjustment nut constrained within the adjustment assembly, and a support nut. A clamp is adjustably connected to the base and a distance between the clamp and the base is adjustable. The clamp includes a first clamp portion and second clamp portion, the first clamp portion having a central portion, a first support surface, and a second support surface. The first support surface includes an angled first portion and a substantially horizontal second portion and is configured to support a first solar panel. The central portion is disposed between the first support surface and the second support surface. A fastener is connected to the clamp and is operable to tighten the second clamp portion to the first clamp portion.

### CROSS-REFERENCE TO RELATED APPLICATION

This application claims the benefit of U.S. Provisional Patent Application No. 63/595,263, which was filed Nov. 1, 2023, and U.S. Provisional Patent Application No. 63/673,660, which was filed Jul. 19, 2024, the disclosures of which are hereby incorporated herein by reference in their entirety.

### BACKGROUND

### Field of the Disclosure

The present disclosure relates to devices, assemblies, and methods for mounting at least one object above a roof surface, and specifically to a height adjustment roof mounting system for securely and adjustably mounting one or more objects such as solar panels to a roof, which allows for use with multiple roof types, multiple solar module thicknesses, and flanged and flangeless solar module frames.

### SUMMARY

Accordingly, provided are devices, assemblies, and methods for securely mounting one or more wires to the underside of a solar module, which allows for use with multiple wire sizes, rail and rail-free solar mounting assemblies, multiple solar module thicknesses, and flanged and flangeless solar module frames.

According to non-limiting embodiments of the disclosure, a roof mount includes a base installable on a roof, an adjustment assembly operatively coupled to the base, the adjustment assembly comprising a partially threaded shaft extending along a first axis substantially perpendicular to the roof, an adjustment nut constrained within the adjustment assembly, and a support nut. A clamp is adjustably connected to the base by the adjustment assembly, and a distance between the clamp and the base is adjustable. The clamp includes a first clamp portion having a central portion, a first support surface and a second support surface. The first support surface includes an angled first portion and a substantially horizontal second portion and the first support surface is configured to support a portion of a first solar panel. The central portion is disposed between the first support surface and the second support surface. The clamp further includes a second clamp portion. The roof mount also includes a fastener connected to the clamp, and the fastener is operable to tighten the second clamp portion to the first clamp portion.

According to other non-limiting embodiments of the disclosure, a roof mount includes a base extending along a second axis, an adjustment assembly operatively coupled to the base, the adjustment assembly comprising a threaded shaft extending along a first axis substantially perpendicular to the second axis, an adjustment nut constrained within the adjustment assembly, and a support nut. A clamp is adjustably connected to the base by the adjustment assembly, and a distance between the clamp and the base is adjustable. The clamp includes a first channel sized to receive and support a first solar panel, the first channel defined between a first top flange and a first bottom flange, the first bottom flange including an angled first portion and a substantially horizontal second portion, the first channel having a first height extending between the first top flange and the first bottom flange, the first height being adjustable. The clamp further includes a second channel sized to receive and support a skirt and sized to receive and support a second solar panel, the second channel defined between a second top flange and a second bottom flange, the second channel having a second height extending between the second top flange and the second bottom flange, the second height being adjustable. The clamp also includes a central portion disposed between the first bottom flange and the second bottom flange, the central portion comprising at least one wall and a horizontal portion defining a slot. The roof mount also includes a first fastener connected to the clamp, the first fastener operable to adjust the first height and second height.

According to other non-limiting embodiments of the disclosure, a roof mounting system includes a roof mount and at least one skirt. The roof mount includes a base installable on a roof, an adjustment assembly operatively coupled to the base, the adjustment assembly comprising a partially threaded shaft extending along a first axis substantially perpendicular to the roof, an adjustment nut constrained within the adjustment assembly, and a support nut. A clamp is adjustably connected to the base by the adjustment assembly, and a distance between the clamp and the base is adjustable. The clamp includes a first clamp portion having a central portion, a first support surface and a second support surface. The first support surface includes an angled first portion and a substantially horizontal second portion and the first support surface is configured to support a portion of a first solar panel. The central portion is disposed between the first support surface and the second support surface. The clamp further includes a second clamp portion. The roof mount also includes a fastener connected to the clamp, and the fastener is operable to tighten the second clamp portion to the first clamp portion. The at least one skirt includes an elongate face, a first protrusion, a first hollow body, a second protrusion, and a second hollow body.

According to other non-limiting embodiments of the disclosure, a roof mount includes a base assembly installable on a roof, the base assembly including a foot, an arm, and a slider. The roof mount further includes a flashing positioned between the foot and the arm, and an adjustment assembly operatively coupled to the slider. The adjustment assembly includes a partially threaded shaft extending along a first axis substantially perpendicular to the roof, an adjustment nut constrained within the adjustment assembly, and a support nut. The roof mount further includes a clamp adjustably connected to the base assembly by the adjustment assembly, and a distance between the clamp and the slider is adjustable. The clamp includes a first clamp portion that includes a central portion, a first support surface and a second support surface. The central portion is disposed between the first support surface and the second support surface. The clamp also includes a second clamp portion, and a first fastener connected to the clamp. The first fastener is operable to tighten the second clamp portion to the first clamp portion.

Further non-limiting illustrative examples of embodiments of the present disclosure will now be set forth in the following numbered clauses.

Clause 1: A roof mount, comprising: a base installable on a roof; an adjustment assembly operatively coupled to the base, the adjustment assembly comprising a partially threaded shaft extending along a first axis substantially perpendicular to the roof, an adjustment nut constrained within the adjustment assembly, and a support nut, a clamp adjustably connected to the base by the adjustment assembly, wherein a distance between the clamp and the base is adjustable, the clamp comprising: a first clamp portion that includes a central portion, a first support surface and a second support surface, the first support surface comprising an angled first portion and a substantially horizontal second portion, the first support surface configured to support a portion of a first solar panel, the central portion disposed between the first support surface and the second support surface; and a second clamp portion; and a fastener connected to the clamp, the fastener operable to tighten the second clamp portion to the first clamp portion.

Clause 2: The roof mount of clause 1, wherein the adjustment assembly is slidable on the base.

Clause 3: The roof mount of clause 1 or 2, further comprising a slider fastener configured to prevent the adjustment assembly from sliding relative to the base.

Clause 4: The roof mount of any of clauses 1-3, wherein the base comprises a seal configured to engage the roof.

Clause 5: The roof mount of any of clauses 1-4, wherein the seal comprises a polymeric material, wherein a bottom surface of the polymeric material comprises a resin layer; and wherein the seal is positioned on a bottom surface of the base.

Clause 6: The roof mount of any of clauses 1-5, wherein an exposed portion of the resin layer is covered by a release sheet.

Clause 7: The roof mount of any of clauses 1-6, wherein the central portion defines an aperture configured to receive the adjustment assembly.

Clause 8: The roof mount of any of clauses 1-7, wherein the adjustment assembly comprises a pedestal operatively coupled to the base, the pedestal receives the partially threaded shaft, and the adjustment nut is constrained within the pedestal.

Clause 9: The roof mount of any of clauses 1-8, wherein the pedestal comprises an upper member, a lower member and two or more side members defining an open space; a first aperture through the upper member; and a second aperture through the lower member, wherein the first aperture and the second aperture are concentric with the first axis and configured to receive the partially threaded shaft.

Clause 10: The roof mount of any of clauses 1-9, wherein the pedestal comprises a first ledge and a second ledge, and wherein the upper member, the first ledge and the second ledge are configured to vertically constrain the adjustment nut within the pedestal.

Clause 11: The roof mount of any of clauses 1-10, wherein the two or more side members and the partially threaded shaft are configured to horizontally constrain the adjustment nut within the pedestal.

Clause 12: The roof mount of any of clauses 1-11, wherein the two or more side members are configured to rotationally constrain the adjustment nut within the pedestal, such that the two or more side members prevent rotation of the adjustment nut.

Clause 13: The roof mount of any of clauses 1-12, wherein the pedestal comprises a first catch extending from the lower member and a first side member of the two or more side members; and a second catch extending from the lower member and a second side member of the two or more side members, wherein the first catch and the second catch are slidably engaged with the base.

Clause 14: The roof mount of any of any of clauses 1-13, wherein the pedestal comprises a pedestal arm extending from the second catch, the pedestal arm comprising an aperture configured to receive a slider fastener, the slider fastener configured to prevent the adjustment assembly from sliding relative to the base.

Clause 15: The roof mount of any of clauses 1-14, wherein the support nut is coupled to the partially threaded shaft below a non-threaded portion of the partially threaded shaft such that the support nut is configured to rotate with the partially threaded shaft, and wherein the support nut is configured to contact and support the central portion such that the clamp is supported above the adjustment assembly.

Clause 16: The roof mount of any of clauses 1-15, wherein a top of the lower clamp portion is contacted by a drive head of the partially threaded shaft such that the partially threaded shaft and the support nut are configured to rotate with respect to the adjustment nut and independently of the lower clamp portion.

Clause 17: The roof mount of any of clauses 1-16, wherein the second support surface is configured to support a portion of a second solar panel.

Clause 18: The roof mount of any of clauses 1-17, wherein the second support surface is configured to support a portion of a skirt.

Clause 19: The roof mount of any of clauses 1-18, further comprising an access defined through the second clamp portion, and a second fastener connected to the clamp, the second fastener operable to tighten the second clamp portion to the first clamp portion.

Clause 20: The roof mount of any of clauses 1-19, wherein the access is defined between the first fastener and the second fastener, and wherein the first fastener and second fastener are positioned at opposite ends of the clamp.

Clause 21: The roof mount of any of clauses 1-20, further comprising a flashing member, the base installable to the roof over the flashing member.

Clause 22: The roof mount of any of clauses 1-21, further comprising a flashing member, the base installable to the roof over the flashing member.

Clause 23: A roof mount, comprising: a base extending along a second axis; an adjustment assembly operatively coupled to the base, the adjustment assembly comprising a threaded shaft extending along a first axis substantially perpendicular to the second axis, an adjustment nut constrained within the adjustment assembly, and a support nut; a clamp adjustably connected to the base by the adjustment assembly, wherein a distance between the clamp and the base is adjustable, the clamp comprising: a first channel sized to receive and support a first solar panel, the first channel defined between a first top flange and a first bottom flange, the first bottom flange including an angled first portion and a substantially horizontal second portion, the first channel having a first height extending between the first top flange and the first bottom flange, the first height being adjustable; and a second channel sized to receive and support a skirt and sized to receive and support a second solar panel, the second channel defined between a second top flange and a second bottom flange, the second channel having a second height extending between the second top flange and the second bottom flange, the second height being adjustable; and a central portion disposed between the first bottom flange and the second bottom flange, the central portion comprising at least one wall and a horizontal portion defining a slot; and a first fastener connected to the clamp, the first fastener operable to adjust the first height and second height.

Clause 24: The roof mount of clause 23, wherein an angled first portion of the first bottom flange and a wall of the at least one wall defines a recess.

Clause 25: The roof mount of clause 23 or 24, wherein the central portion is configured to receive the adjustment assembly.

Clause 26: The roof mount of any of clauses 23-25, wherein the central portion comprises a through hole configured to receive the adjustment assembly and a threaded aperture configured to receive the first fastener.

Clause 27: The roof mount of any of clauses 23-26, wherein the adjustment assembly is slidable on the base.

Clause 28: The roof mount of any of clauses 23-27, further comprising a slider fastener configured to prevent the adjustment assembly from sliding relative to the base.

Clause 29: The roof mount of any of clauses 23-28, wherein the base comprises a seal configured to engage a roof.

Clause 30: The roof mount of any of clauses 23-29, wherein the seal comprises a polymeric material, wherein a bottom surface of the polymeric material comprises a resin layer; and wherein the seal is positioned on a bottom surface of the base.

Clause 31: The roof mount of any of clauses 23-30, wherein an exposed portion of the resin layer is covered by a release sheet.

Clause 32: The roof mount of any of clauses 23-31, wherein the horizontal portion of the central portion defines an aperture configured to receive the adjustment assembly.

Clause 33: The roof mount of any of clauses 23-32, wherein the adjustment assembly comprises a pedestal operatively coupled to the base, the pedestal receives the partially threaded shaft, and the adjustment nut is constrained within the pedestal.

Clause 34: The roof mount of any of clauses 23-33, wherein the pedestal comprises: an upper member, a lower member and two or more side members defining an open space; a first aperture through the upper member; and a second aperture through the lower member, wherein the first aperture and the second aperture are concentric with the first axis and configured to receive the partially threaded shaft.

Clause 35: The roof mount of any of clauses 23-34, wherein the pedestal comprises a first ledge and a second ledge, and wherein the upper member, the first ledge and the second ledge are configured to vertically constrain the adjustment nut within the pedestal.

Clause 36: The roof mount of any of clauses 23-35, wherein the two or more side members and the partially threaded shaft are configured to horizontally constrain the adjustment nut within the pedestal.

Clause 37: The roof mount of any of clauses 23-36, wherein the two or more side members are configured to rotationally constrain the adjustment nut within the pedestal, such that the two or more side members prevent rotation of the adjustment nut.

Clause 38: The roof mount of any of clauses 23-37, wherein the pedestal comprises a first catch extending from the lower member and a first side member of the two or more side members; and a second catch extending from the lower member and a second side member of the two or more side members, wherein the first catch and the second catch each define a groove configured to slidingly couple to a top flange of the base, and wherein the first catch and the second catch are slidably engaged with the base.

Clause 39: The roof mount of any of clauses 23-38, wherein the pedestal comprises a pedestal arm extending from the second catch, the pedestal arm comprising an aperture configured to receive a slider fastener configured to prevent the adjustment assembly from sliding relative to the base.

Clause 40: The roof mount of any of clauses 23-39, wherein the support nut is coupled to the partially threaded shaft below a non-threaded portion of the partially threaded shaft such that the support nut is configured to rotate with the partially threaded shaft, and wherein the support nut is configured to contact and support the central portion such that the clamp is supported above the adjustment assembly.

Clause 41: The roof mount of any of clauses 23-40, wherein a top of the lower clamp portion is contacted by a drive head of the partially threaded shaft such that the partially threaded shaft and the support nut are configured to rotate with respect to the adjustment nut and independently of the lower clamp portion.

Clause 42: The roof mount of any of clauses 23-41, wherein the second channel is configured to receive and support a portion of a second solar panel.

Clause 43: The roof mount of any of clauses 23-42, wherein the second channel is configured to receive and support a portion of a skirt.

Clause 44: The roof mount of any of clauses 23-43, further comprising an access defined through the second clamp portion, and a second fastener connected to the clamp, the second fastener operable to adjust the first height and second height.

Clause 45: The roof mount of any of clauses 23-44, wherein the access is defined between the first fastener and the second fastener, and wherein the first fastener and second fastener are positioned at opposite ends of the clamp.

Clause 46: The roof mount of any of clauses 23-45, further comprising a flashing member, the base installable to a roof over the flashing member.

Clause 47: The roof mount of any of clauses 23-46, further comprising a flashing member, the base installable to a roof over the flashing member.

Clause 48: The roof mount of any of clauses 23-47, wherein the flashing member comprises: a substantially flat portion; a raised portion protruding from the substantially flat portion; and an aperture concentric with the raised portion extending through the flashing member.

Clause 49: The roof mount of any of clauses 23-48, further comprising a gasket configured to engage with the raised portion and the aperture.

Clause 50: The roof mount of any of clauses 23-49, wherein the gasket comprises: a through hole; a cylindrical upper portion extending above the raised portion; and a frustoconical lower portion engaged with an inner surface of the raised portion.

Clause 51: The roof mount of any of clauses 23-50, wherein the base and the flashing member are fastened to the roof with a threaded fastener extending through the base, the gasket, and the raised portion of the flashing member.

Clause 52: The roof mount of any of clauses 23-51, wherein the base comprises a raised central portion and a recess extending from a bottom surface of the base into the raised central portion, the recess configured to receive the raised portion of the flashing member and the gasket.

Clause 53: The roof mount of any of clauses 23-52, wherein the base comprises a base aperture extending through the raised central portion and the recess, the base aperture configured to receive the threaded fastener.

Clause 54: A roof mounting system, comprising: a roof mount comprising: a base installable on a roof; an adjustment assembly operatively coupled to the base, the adjustment assembly comprising a partially threaded shaft extending along a first axis substantially perpendicular to the roof, an adjustment nut constrained within the adjustment assembly, and a support nut, a clamp adjustably connected to the base by the adjustment assembly, wherein a distance between the clamp and the base is adjustable, the clamp comprising: a first clamp portion that includes a central portion, a first support surface and a second support surface, the first support surface comprising an angled first portion and a substantially horizontal second portion, the first support surface configured to support a portion of a first solar panel, the second support surface configured to support a portion of a skirt and configured to support a portion of second solar panel, the central portion disposed between the first support surface and the second support surface; and a second clamp portion; and a fastener connected to the clamp, the fastener operable to tighten the second clamp portion to the first clamp portion; and at least one skirt, wherein each of the at least one skirt comprises: an elongate face; a first protrusion; a first hollow body; a second protrusion; and a second hollow body.

Clause 55: The roof mounting system of clause 54, wherein the first protrusion and the first hollow body of the skirt are received and supported by the second support surface and the second clamp portion, or wherein the first hollow body of the skirt is received and supported by the second support surface and the second clamp portion, or wherein the second protrusion and the second hollow body of the skirt are received and supported by the second support surface and the second clamp portion, or wherein the second hollow body of the skirt is received and supported by the second support surface and the second clamp portion.

Clause 56: The roof mounting system of clause 54 or 55, wherein: the second support surface comprises ridges; a clamping surface of the second clamp portion comprise ridges; a surface of the first protrusion comprises ridges; a first surface, a second surface, and a third surface of the first hollow body each comprise ridges, a surface of the second protrusion comprises ridges; a first surface and a second surface of the second hollow body comprise ridges; the ridges of the clamping surface of the second clamp portion mate with the ridges of either the surface of the first protrusion, the first surface of the first hollow body, the surface of the second protrusion, or the first surface of the second hollow body and the ridges of the second support surface mate with the ridges of either the second surface of the first hollow body or the second surface of the second hollow body when the skirt is received and supported by the second support surface and the second clamp portion.

Clause 57: The roof mounting system of any of clauses 54-56, further comprising at least one corner cover, wherein each of the at least one corner cover comprises: a first portion and second portion connected at a corner joint, a first flange extending from the top of the first portion; a second flange extending from the bottom of the first portion and having a first lower tab; a third flange extending from the top of the second portion; and a fourth flange extending from the bottom of the second portion and having a second lower tab, wherein the at least one corner cover is configured to snap over a corner of the roof mounting system where two skirts meet after the two skirts have been installed.

Clause 58: The roof mounting system of any of clauses 54-57, wherein one or more of the at least one corner covers is an interior corner cover such that the first flange, the second flange, the third flange, and the fourth flange extend perpendicularly away from each other and clip to a first and second skirt of the at least one skirt.

Clause 59: The roof mounting system of any of clauses 54-58, wherein one or more of the at least one corner covers is an exterior corner cover such that the first flange, the second flange, the third flange, and the fourth flange extend perpendicularly toward each other and clip to a first and second skirt of the at least one skirt.

Clause 60: The roof mounting system of any of clauses 54-59, further comprising at least one cap, wherein each of the at least one cap comprises: a pair of upper inserts configured to mate with the first hollow body of a skirt of the at least one skirt; a pair of lower inserts configured to mate with the second hollow body of a skirt of the at least one skirt; and a face connector connecting the pair of upper inserts and the pair of lower inserts.

Clause 61: The roof mounting system of any of clauses 54-60, wherein the at least one cap is received by an end of a first skirt of the at least one skirt such that the first hollow body of the first skirt receives an upper insert of the pair of upper inserts and the second hollow body of the first skirt receives a lower insert of the pair of lower inserts such that the face connecter is coplanar with the elongate face of the first skirt.

Clause 62: The roof mounting system of any of clauses 54-61, wherein the at least one cap is further received by an end of a second skirt of the at least one skirt such that the first hollow body of the second skirt receives an upper insert of the pair of upper inserts and the second hollow body of the second skirt receives a lower insert of the pair of lower inserts, such that the elongate face of the first skirt and the elongate face of the second skirt are held coplanar to each other and to the face connector.

Clause 63: The roof mounting system of any of clauses 54-62, wherein the upper inserts of the pair of upper inserts comprise fingers and the lower inserts of the pair of lower inserts comprise fingers.

Clause 64: A roof mount, comprising: a base assembly installable on a roof, the base assembly comprising a foot, an arm, and a slider; a flashing positioned between the foot and the arm; an adjustment assembly operatively coupled to the slider, the adjustment assembly comprising a partially threaded shaft extending along a first axis substantially perpendicular to the roof, an adjustment nut constrained within the adjustment assembly, and a support nut, a clamp adjustably connected to the base assembly by the adjustment assembly, wherein a distance between the clamp and the slider is adjustable, the clamp comprising: a first clamp portion that includes a central portion, a first support surface and a second support surface, the central portion disposed between the first support surface and the second support surface; and a second clamp portion; and a first fastener connected to the clamp, the first fastener operable to tighten the second clamp portion to the first clamp portion.

Clause 65: The roof mount of clause 64, wherein the arm comprises: a lower horizontal portion including two downwardly extending lips protruding from a bottom surface; a recess extending into the bottom surface; an aperture extending through the bottom surface and the recess between the lips; an upstanding portion; and an upper horizontal portion extending from the upstanding portion, the upper horizontal portion comprising a slot.

Clause 66: The roof mount of clause 64 or 65, wherein the arm comprises an offset Z shape, such that the lower horizontal portion and the upstanding portion define an obtuse angle, the upstanding portion and the upper horizontal portion define an obtuse angle, and a top horizontal surface and a bottom horizontal surface are parallel.

Clause 67: The roof mount of any of clauses 64-66, wherein the foot comprises: a hollow raised portion having opposing flanges extending from the top of the foot in opposite directions; two vertical walls forming the hollow raised portion; a bottom flange extending from a bottom of one of the two vertical walls, the bottom flange having at least one aperture; a recess in the bottom surface of the foot, the recess offset from the at least one aperture; and a first threaded stud extending from the recess through the hollow raised portion and out of the top of the foot.

Clause 68: The roof mount of any of clauses 64-67, wherein the slider comprises: two opposed upstanding slider members extending from a slider base and configured to slidably engage with the adjustment assembly, two base protrusions extending from a bottom surface of the slider base; and a slider aperture extending through the slider base and configured to receive a second threaded stud, wherein the second threaded stud extends through the slider aperture and the slot of the arm to fasten the slider to the arm, and wherein the first threaded stud pierces and extends through the flashing and operatively couples the arm to the foot.

Clause 69: The roof mount of any of clauses 64-68 wherein the flashing comprises a substantially flat portion pierceable by the first threaded stud, the substantially flat portion configured to be supported by the foot and configured to support the arm, and wherein the flashing is monolithically formed.

Clause 70: The roof mount of any of clauses 64-69, wherein the flashing comprises a substantially flat shape and is configured to replace a flat roof tile.

Clause 71: The roof mount of any of clauses 64-70, wherein the flashing comprises an S shape and is configured to replace an S shaped roof tile.

Clause 72: The roof mount of any of clauses 64-71, wherein the flashing comprises a W shape and is configured to replace a W shaped roof tile.

Further details and advantages of the various examples described in detail herein will become clear upon reviewing the following detailed description of the various examples in conjunction with the accompanying drawing figures.

### BRIEF DESCRIPTION OF THE DRAWINGS

Additional advantages and details are explained in greater detail below with reference to the exemplary embodiments that are illustrated in the accompanying schematic figures, in which:

FIG. 1 is a perspective view of a roof mount according to some non-limiting embodiments of the present disclosure;

FIG. 2 is an exploded perspective view of the roof mount of FIG. 1 according to some non-limiting embodiments of the present disclosure;

FIG. 3 is a perspective view of the roof mount of FIG. 1 according to some non-limiting embodiments of the present disclosure;

FIG. 4 is a sectional perspective view of the roof mount of FIG. 1 according to some non-limiting embodiments of the present disclosure;

FIG. 5 is a side view of the roof mount of FIG. 1 according to some non-limiting embodiments of the present disclosure;

FIG. 6 is a sectional side view of the roof mount of FIG. 1 according to some non-limiting embodiments of the present disclosure;

FIG. 7 is a front view of the roof mount of FIG. 1 according to some non-limiting embodiments of the present disclosure;

FIG. 8 is a perspective view of the roof mount of FIG. 1 according to some non-limiting embodiments of the present disclosure;

FIG. 9 is a perspective view of the roof mount of FIG. 1 according to some non-limiting embodiments of the present disclosure;

FIG. 10 is a perspective view of the roof mount of FIG. 1 according to some non-limiting embodiments of the present disclosure;

FIG. 11 is a perspective view of an implementation of the roof mount of FIG. 1 according to some non-limiting embodiments of the present disclosure;

FIG. 12 is a side view of an implementation of the roof mount of FIG. 1 securing a solar panel according to some non-limiting embodiments of the present disclosure;

FIG. 13 is a side profile view of a first and second clamp portion of the roof mount of FIG. 1 according to some non-limiting embodiments of the present disclosure;

FIG. 14 is a perspective view of a roof mount according to some non-limiting embodiments of the present disclosure;

FIG. 15 is an exploded perspective view of the roof mount of FIG. 14 according to some non-limiting embodiments of the present disclosure;

FIG. 16 is a side view of the roof mount of FIG. 14 according to some non-limiting embodiments of the present disclosure;

FIG. 17 is a sectional side view of the roof mount of FIG. 14 according to some non-limiting embodiments of the present disclosure;

FIG. 18 is a front view of the roof mount of FIG. 14 according to some non-limiting embodiments of the present disclosure;

FIG. 19 is a perspective view of the roof mount of FIG. 14 according to some non-limiting embodiments of the present disclosure;

FIG. 20 is an exploded perspective view of a base assembly of the roof mount of FIG. 14 according to some non-limiting embodiments of the present disclosure;

FIG. 21 is an exploded perspective view of a base assembly of the roof mount of FIG. 14 according to some non-limiting embodiments of the present disclosure;

FIG. 22 is a perspective view of a first and second clamp portion of a roof mount according to some non-limiting embodiments of the present disclosure;

FIG. 23 is a side profile view of the first and second clamp portion of a roof mount of FIG. 22 according to some non-limiting embodiments of the present disclosure;

FIG. 24 is a perspective view of an adjustment assembly and a clamp of a roof mount according to some non-limiting embodiments of the present disclosure;

FIG. 25 is a front view of the adjustment assembly and clamp of FIG. 24 according to some non-limiting embodiments of the present disclosure;

FIG. 26 is a perspective view of a roof mount according to some non-limiting embodiments of the present disclosure;

FIG. 27 is a front view of the roof mount of FIG. 26 according to some non-limiting embodiments of the present disclosure;

FIG. 28 is a perspective view of a roof mount according to some non-limiting embodiments of the present disclosure;

FIG. 29 is a front view of the roof mount of FIG. 28 according to some non-limiting embodiments of the present disclosure;

FIG. 30 is a side profile view of a skirt of a roof mounting system according to some non-limiting embodiments of the present disclosure;

FIG. 31 is a perspective view of the skirt of FIG. 30 according to some non-limiting embodiments of the present disclosure;

FIG. 32 is a perspective view of the skirt of FIG. 30 according to some non-limiting embodiments of the present disclosure;

FIG. 33 is a perspective view of the skirt of FIG. 30 according to some non-limiting embodiments of the present disclosure;

FIG. 34 is a perspective view of an inside skirt corner of a roof mounting system according to some non-limiting embodiments of the present disclosure;

FIG. 35 is a perspective view of the inside skirt corner of FIG. 34 according to some non-limiting embodiments of the present disclosure;

FIG. 36 is a top view of the inside skirt corner of FIG. 34 according to some non-limiting embodiments of the present disclosure;

FIG. 37 is a bottom view of the inside skirt corner of FIG. 34 according to some non-limiting embodiments of the present disclosure;

FIG. 38 is a perspective view of an outside skirt corner of a roof mounting system according to some non-limiting embodiments of the present disclosure;

FIG. 39 is a perspective view of the outside skirt corner of FIG. 38 according to some non-limiting embodiments of the present disclosure;

FIG. 40 is a top view of the outside skirt corner of FIG. 38 according to some non-limiting embodiments of the present disclosure;

FIG. 41 is a bottom view of the outside skirt corner of FIG. 38 according to some non-limiting embodiments of the present disclosure;

FIG. 42 is a perspective view of a skirt cap of a roof mounting system according to some non-limiting embodiments of the present disclosure;

FIG. 43 is a side profile view of the skirt cap of FIG. 42 according to some non-limiting embodiments of the present disclosure;

FIG. 44 is a perspective view of the skirt cap of FIG. 42 according to some non-limiting embodiments of the present disclosure;

FIG. 45 is a perspective view of a portion of a roof mounting system implemented in a solar array according to some non-limiting embodiments of the present disclosure;

FIG. 46 is a perspective view of a portion of a roof mounting system implemented in a solar array according to some non-limiting embodiments of the present disclosure;

FIG. 47 is a perspective view of a roof mounting system implemented in a solar array on a roof according to some non-limiting embodiments of the present disclosure;

FIG. 48 is a perspective view of a roof mount according to some non-limiting embodiments of the present disclosure;

FIG. 49 is a perspective view of the roof mount of FIG. 48 according to some non-limiting embodiments of the present disclosure;

FIG. 50 is a perspective view of a roof mount according to some non-limiting embodiments of the present disclosure;

FIG. 51 is a perspective view of the roof mount of FIG. 50 according to some non-limiting embodiments of the present disclosure;

FIG. 52 is a perspective view of a roof mount according to some non-limiting embodiments of the present disclosure;

FIG. 53 is a perspective view of the roof mount of FIG. 52 according to some non-limiting embodiments of the present disclosure;

FIG. 54 is a perspective view of an assembly of a roof mount according to some non-limiting embodiments of the present disclosure;

FIG. 55 is an exploded perspective view of an assembly of a roof mount according to some non-limiting embodiments of the present disclosure;

FIG. 56 is an exploded perspective view of an assembly of a roof mount according to some non-limiting embodiments of the present disclosure;

FIG. 57 is a front view of a base assembly and flashing of the roof mount of FIG. 50 according to some non-limiting embodiments of the present disclosure;

FIG. 58 is a front view of a base assembly, an adjustment assembly, and a clamp according to some non-limiting embodiments of the present disclosure;

FIG. 59 is a front view of a base assembly and flashing of the roof mount of FIG. 48 according to some non-limiting embodiments of the present disclosure;

FIG. 60 is a front view of a base assembly, an adjustment assembly, and a clamp according to some non-limiting embodiments of the present disclosure;

FIG. 61 is a perspective view of a base assembly of a roof mount according to some non-limiting embodiments of the present disclosure;

FIG. 62 is a perspective view of a base assembly of a roof mount according to some non-limiting embodiments of the present disclosure;

FIG. 63 is a side view of a base assembly of a roof mount according to some non-limiting embodiments of the present disclosure;

FIG. 64 is a side view of a base assembly of a roof mount according to some non-limiting embodiments of the present disclosure;

FIG. 65 is an exploded perspective view of a portion of a base assembly according to some non-limiting embodiments of the present disclosure;

FIG. 66 is an exploded front view of a portion of a base assembly to some non-limiting embodiments of the present disclosure;

FIG. 67 is an exploded perspective view of a portion of a base assembly according to some non-limiting embodiments of the present disclosure;

FIG. 68 is an exploded perspective view of a portion of a base assembly according to some non-limiting embodiments of the present disclosure;

FIG. 69 is an exploded perspective view of a portion of a base assembly and a flashing according to some non-limiting embodiments of the present disclosure;

FIG. 70 is a perspective view of an implementation of a roof mount according to some non-limiting embodiments of the present disclosure; and

FIG. 71 is a perspective view of a roof mounting system implemented on a roof according to some non-limiting embodiments of the present disclosure.

Corresponding reference characters indicate corresponding parts throughout the several views. The exemplifications set out herein illustrate exemplary embodiments of the disclosure, and such embodiment are not to be construed as limiting the scope of the disclosure in any manner.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments. Hence, specific dimensions and other physical characteristics related to the embodiments disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments as they are oriented in the drawing figures. Some non-limiting embodiments may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” As used in the specification and the claims, the singular form of “a,” “an,” and “the” include plural referents, such as unless the context clearly dictates otherwise. Where only one item is intended, the term “one” or similar language is used. Also, as used herein, the terms “comprising,” “including,” “has,” “have,” “having,” variations thereof, and the like are intended to be open-ended terms and are meant to encompass the items listed thereafter and equivalents thereof as well as additional items. Further, the phrase “based on” is intended to mean “based at least partially on” unless explicitly stated otherwise. In addition, reference to an action being “based on” a condition may refer to the action being “in response to” the condition.

Unless specified or limited otherwise, the terms “fastened,” “attached,” “mounted,” “connected,” “supported,” “coupled,” and variations thereof are used broadly and encompass both direct and indirect fastenings, attachments, mountings, connections, supports, and couplings. Further, these terms are not restricted to physical or mechanical connections or couplings unless otherwise specified. As used herein, when referring to a part of a component, the term “member” and/or “members” may be used to refer to features, elements, and/or parts of a whole component that are monolithic, monolithically formed, unitary and/or unitarily formed with the whole component, unless it is explicitly described to the contrary or unless the context clearly dictates otherwise.

Non-limiting embodiments of the present disclosure are generally directed to devices, assemblies, and methods for mounting at least one object above a roof surface, and specifically to a height adjustment roof mounting system for securely and adjustably mounting one or more objects such as solar panels to a roof, which allows for use with multiple roof types, multiple solar module thicknesses, and flanged and flangeless solar module frames.

In some non-limiting embodiments, a roof mount may include a base installable on a roof, an adjustment assembly operatively coupled to the base, the adjustment assembly comprising a partially threaded shaft extending along a first axis substantially perpendicular to the roof, an adjustment nut constrained within the adjustment assembly, and a support nut. A clamp may be adjustably connected to the base by the adjustment assembly, and a distance between the clamp and the base may be adjustable. The clamp may include a first clamp portion having a central portion, a first support surface and a second support surface. The first support surface may include an angled first portion and a substantially horizontal second portion and the first support surface may be configured to support a portion of a first solar panel. The central portion may be disposed between the first support surface and the second support surface. The clamp may further include a second clamp portion. The roof mount may also include a fastener connected to the clamp, and the fastener may be operable to tighten the second clamp portion to the first clamp portion.

In some non-limiting embodiments, the adjustment assembly may be slidable on the base. In some non-limiting embodiments, the roof mount may further include a slider fastener configured to prevent the adjustment assembly from sliding relative to the base.

In some non-limiting embodiments, the base may include a seal configured to engage the roof. In some non-limiting embodiments, the seal may include a polymeric material, a bottom surface of the polymeric material may include a resin layer, and the seal may be positioned on a bottom surface of the base. In some non-limiting embodiments, an exposed portion of the resin layer may be covered by a release sheet.

In some non-limiting embodiments, the central portion may define an aperture configured to receive the adjustment assembly. In some non-limiting embodiments, the adjustment assembly may include a pedestal operatively coupled to the base, the pedestal may receive the partially threaded shaft, and the adjustment nut may be constrained within the pedestal. In some non-limiting embodiments, the pedestal may include an upper member, a lower member and two or more side members defining an open space, a first aperture through the upper member, and a second aperture through the lower member, and the first aperture and the second aperture may be concentric with the first axis and configured to receive the partially threaded shaft.

In some non-limiting embodiments, the pedestal may include a first ledge and a second ledge, and the upper member, the first ledge and the second ledge may be configured to vertically constrain the adjustment nut within the pedestal. In some non-limiting embodiments, the two or more side members and the partially threaded shaft may be configured to horizontally constrain the adjustment nut within the pedestal. In some non-limiting embodiments, the two or more side members may be configured to rotationally constrain the adjustment nut within the pedestal, such that the two or more side members prevent rotation of the adjustment nut.

In some non-limiting embodiments, the pedestal may include a first catch extending from the lower member and a first side member of the two or more side members, and a second catch extending from the lower member and a second side member of the two or more side members, and the first catch and the second catch may be slidably engaged with the base. In some non-limiting embodiments, the pedestal may include a pedestal arm extending from the second catch. In some non-limiting embodiments, the pedestal arm may include an aperture configured to receive a slider fastener, and the slider fastener may be configured to prevent the adjustment assembly from sliding relative to the base.

In some non-limiting embodiments, the support nut may be coupled to the partially threaded shaft below a non-threaded portion of the partially threaded shaft such that the support nut is configured to rotate with the partially threaded shaft and the support nut may be configured to contact and support the central portion such that the clamp is supported above the adjustment assembly. In some non-limiting embodiments, a top of the lower clamp portion may be contacted by a drive head of the partially threaded shaft such that the partially threaded shaft and the support nut may be configured to rotate with respect to the adjustment nut and independently of the lower clamp portion.

In some non-limiting embodiments, the second support surface may be configured to support a portion of a second solar panel. In some non-limiting embodiments, the second support surface may be configured to support a portion of a skirt.

In some non-limiting embodiments, the roof mount may further include an access defined through the second clamp portion, and a second fastener connected to the clamp, and the second fastener may be operable to tighten the second clamp portion to the first clamp portion. In some non-limiting embodiments, the access may be defined between the first fastener and the second fastener, and the first fastener and second fastener may be positioned at opposite ends of the clamp.

In some non-limiting embodiments, the roof mount may further include a flashing member and the base may be installable to the roof over the flashing member.

In this way, embodiments of the present disclosure allow for a height adjustment roof mounting system for securely and adjustably mounting one or more objects such as solar panels to a roof, which allows for use with multiple roof types, multiple solar module thicknesses, and flanged and flangeless solar module frames.

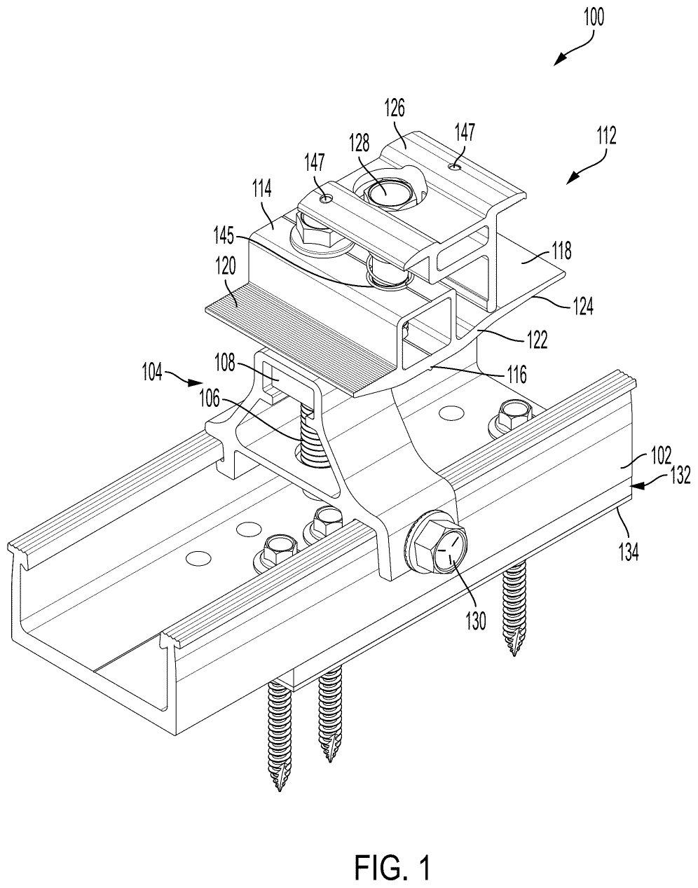

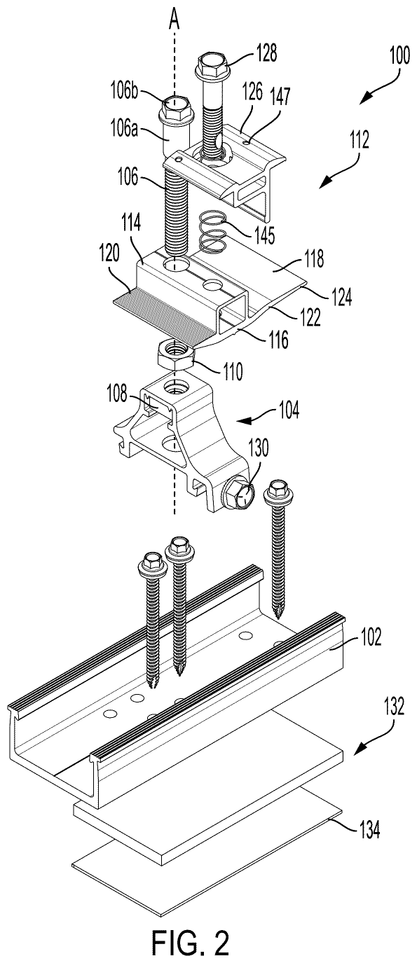

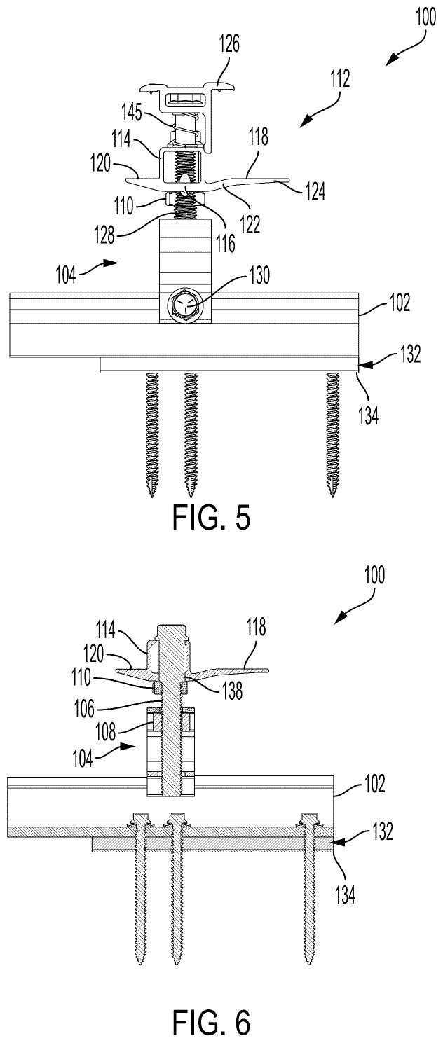

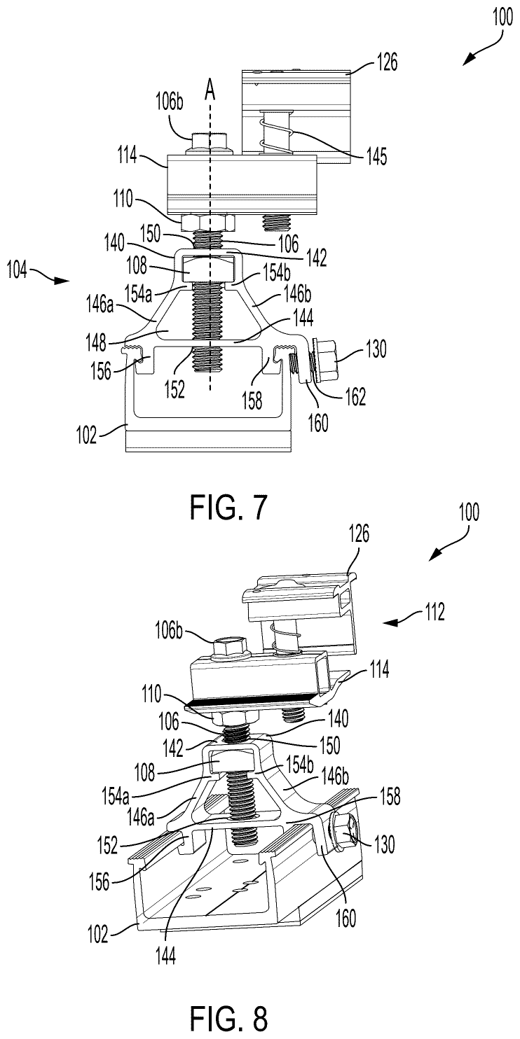

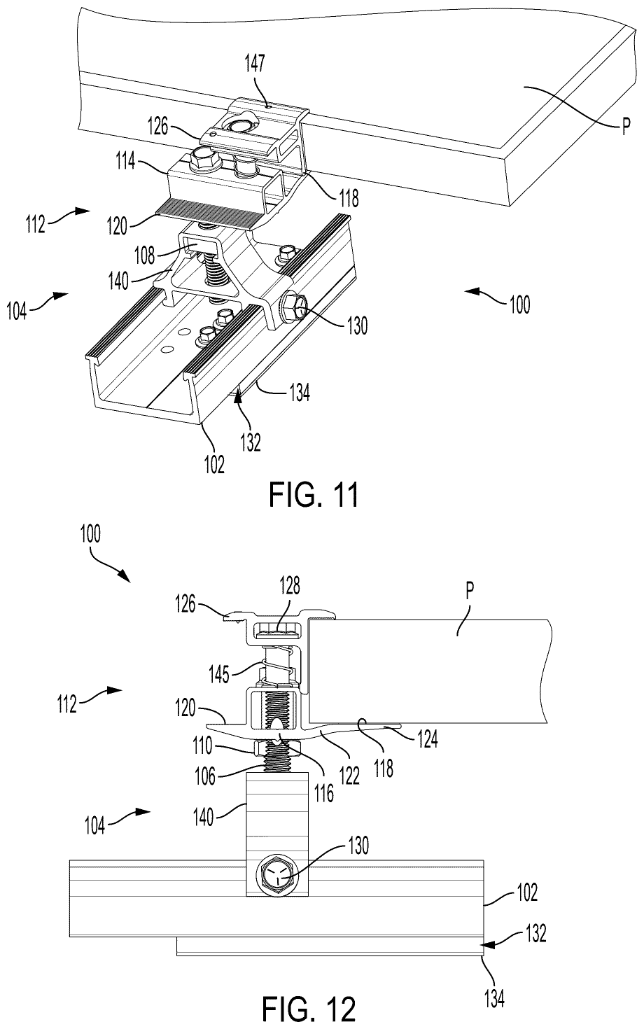

Referring now to FIGS. 1-13, FIGS. 1-13 are various views of roof mount 100 and features thereof according to some non-limiting embodiments of the present disclosure. As shown in FIGS. 1-14, roof mount 100 may include base 102 installable on a roof, and adjustment assembly 104 operatively coupled to base 102. Adjustment assembly 104 may include partially threaded shaft 106 extending along first axis (e.g., first axis A as shown in FIGS. 2 and 7), which may be substantially perpendicular to the roof. Adjustment assembly 104 may further include adjustment nut 108 constrained within adjustment assembly 104, and support nut 110. Clamp 112 may be adjustably connected to base 102 by adjustment assembly 104, and a distance between clamp 112 and base 102 may be adjustable. Clamp 112 may include first clamp portion 114 having central portion 116, first support surface 118 and second support surface 120. First support surface 118 may include angled first portion 122 and substantially horizontal second portion 124, and first support surface 118 may be configured to support a portion of a first solar panel (e.g., solar panel P as shown in FIGS. 11 and 12). Central portion 116 may be disposed between first support surface 118 and second support surface 120. In some non-limiting embodiments, as shown in FIG. 4, central portion 116 may define mounting aperture 138 configured to receive adjustment assembly 104. Clamp 112 may further include second clamp portion 126.

In exemplary embodiments, lower clamp 114 may have a length that is longer than the length of second clamp portion 126. In some non-limiting embodiments, this difference in length may allow access to adjustment assembly 104, and in particular, to partially threaded shaft 106, and more particularly, to drive head 106b of partially threaded shaft 106 without impediment by second clamp portion 126. In this way, adjustment assembly 104 may be adjusted from above second clamp portion 126. This configuration may also reduce material and labor costs.

Roof mount 100 may also include a fastener 128 connected to clamp 112, and fastener 128 may be operable to tighten second clamp portion 126 to first clamp portion 114. This bias may act to hold the first clamp portion 114 and second clamp portion 126 in an open position to receive a skirt or second solar panel before adjusting the distance between the first clamp portion 114 and second clamp portion 126 via fastener 128. In some non-limiting embodiments, fastener 128 may be received within a fastener through hole in second clamp portion 126 and a threaded aperture in first clamp portion 114 to allow tightening of second clamp portion 126 to first clamp portion 114. In some non-limiting embodiments, second clamp portion 126 may further include a counterbore access that allows a head of fastener 128 to be recessed into second clamp portion 126 when fastener 128 is tightened.

As further shown in FIGS. 1-13, in some non-limiting embodiments, adjustment assembly 104 may be slidable on base 102. In some non-limiting embodiments, roof mount 100 may further include slider fastener 130 configured to prevent adjustment assembly 104 from sliding relative to base 102.

In some non-limiting embodiments, roof mount 100 may include spring 145 between first clamp portion 114 and second clamp portion 126, and spring 145 may be configured to bias second clamp portion 126 with respect to first clamp portion 114. In some non-limiting embodiments, second clamp portion 126 may include grounding pins 147 and grounding pins 147 may be configured to pierce a surface (e.g., an anodized surface) of a solar panel, a solar panel frame, and/or a skirt to electrically bond and/or electrically ground the respective components.

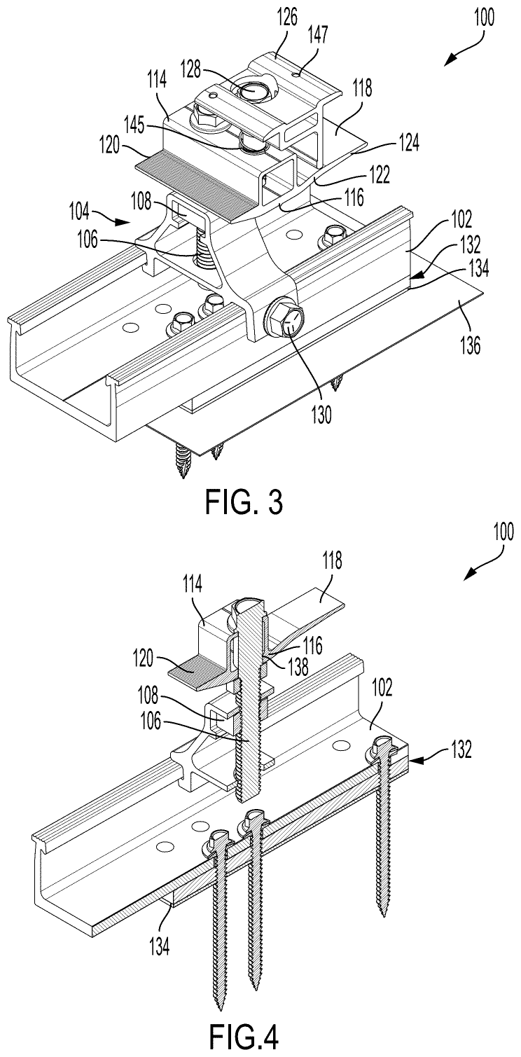

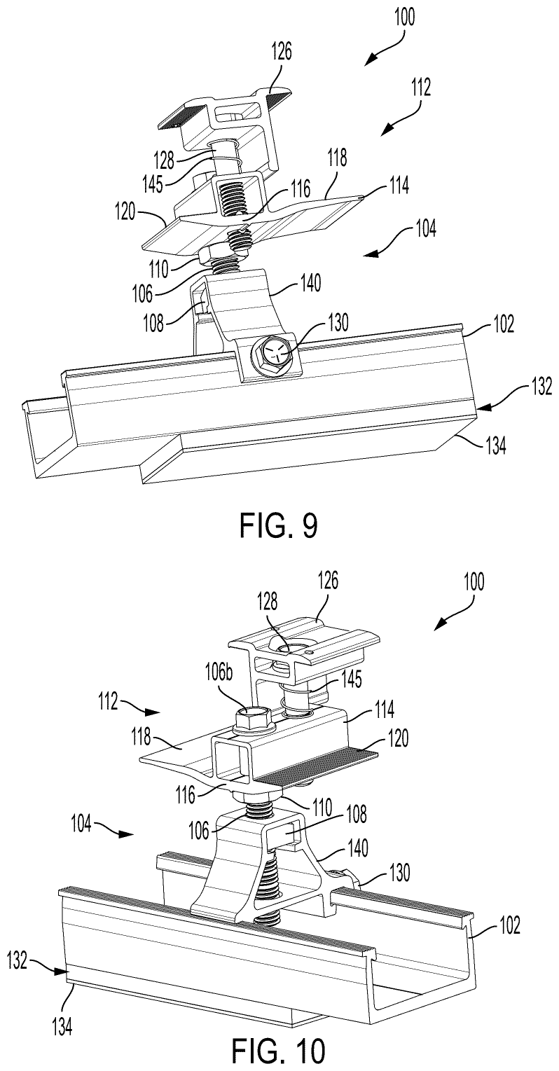

In some non-limiting embodiments, base 102 may include seal 132 configured to engage the roof. In some non-limiting embodiments, seal 132 may include polymeric material, and a bottom surface of the polymeric material may include resin layer 134. In some non-limiting embodiments, seal 132 may be positioned on a bottom surface of base 102 (e.g., bottom surface 102a of base 102 shown in FIG. 9). As shown in FIG. 3, in some non-limiting embodiments, an exposed portion of resin layer 134 may be covered by release sheet 136. In some non-limiting embodiments, release sheet 136 may be removed to expose the entire resin layer 134 or a greater portion or surface area of resin layer 134.

With reference to FIG. 7, in some non-limiting embodiments, adjustment assembly 104 may include pedestal 140 operatively coupled to base 102. Pedestal 140 may receive partially threaded shaft 106, and adjustment nut 108 may be constrained within pedestal 140. In some non-limiting embodiments, pedestal 140 may include upper member 142, lower member 144 and two or more side members 146a, 146b defining open space 148. Pedestal 140 may further include first aperture 150 through upper member 142, and second aperture 152 through lower member 144, and first aperture 150 and second aperture 152 may be concentric with first axis A. First aperture 150 and second aperture 152 may be configured to receive partially threaded shaft 106.

As further shown in FIG. 7, in some non-limiting embodiments, pedestal 140 may include first ledge 154a and second ledge 154b. First ledge 154a and second ledge 154b and upper member 142 may be configured to constrain adjustment nut 108 within pedestal 140. In some non-limiting embodiments, two or more side members 146a, 146b and partially threaded shaft 106 may be configured to horizontally constrain adjustment nut 108 within pedestal 104. In some non-limiting embodiments, two or more side members 146a, 146b may be configured to rotationally constrain adjustment nut 108 within pedestal 140, such that two or more sidewalls 146a, 146b prevent rotation of adjustment nut 108.

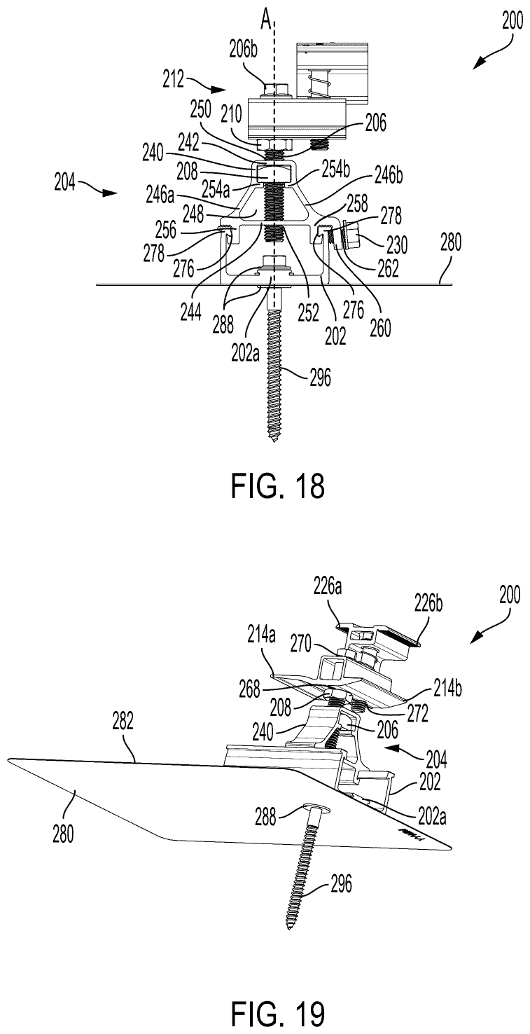

With continued reference to FIG. 7, in some non-limiting embodiments, pedestal 140 may include first catch 156 extending from lower member 144 and first side member 146a, and second catch 158 extending from lower member 144 and second side member 146b. First catch 156 and second catch 158 may be slidably engaged with base 102. In some non-limiting embodiments, first catch 156 and second catch 158 may include outward facing grooves which are configured to receive inwardly extending flanges of base 102 (e.g., flange 278 of base 202 shown in FIG. 18). For example, the flanges of base 102 may include a dovetail shape for engaging with first catch 156, second catch 158 or grooves thereof. In some non-limiting embodiments, pedestal 140 may include pedestal arm 160 extending from second catch 158. In some non-limiting embodiments, pedestal arm 160 may include aperture 152 configured to receive slider fastener 130. Slider fastener 130 may be configured to prevent adjustment assembly 104 from sliding relative to base 102.

In some non-limiting embodiments, support nut 110 may be coupled to partially threaded shaft 106 below and tightened against non-threaded portion 106a (e.g., non-threaded portion 106a shown in FIG. 2) of partially threaded shaft 106 such that support nut 110 is securely fixed to and configured to rotate with partially threaded shaft 106. Support nut 110 may be configured to contact and support central portion 116 of first clamp portion 114 such that clamp 112 is supported above adjustment assembly 104. In some non-limiting embodiments, a top of first clamp portion 114 may be contacted by drive head 106b of partially threaded shaft 106 such that partially threaded shaft 106 and support nut 110 are configured to rotate with respect to adjustment nut 108 and independently of first clamp portion 114.

In some non-limiting embodiments, drive head 106b may sit above the top surface of the first clamp portion 114 and support nut 110 may sit below and support the bottom surface of central portion 116, and partially threaded shaft 106 may be received within mounting aperture 138 which may be an unthreaded clearance aperture. The distance between the bottom of drive head 106b and the top of support nut 110 may be greater than the height of central portion 116 of first clamp portion 114 from the bottom surface of central portion 116 to the top surface of first clamp portion 114. This exemplary configuration may allow partially threaded shaft 106 to rotate freely within first clamp portion 114 and for a drill or other tool to move partially threaded shaft 106 up and down within adjustment nut 108 without rotating clamp 112 and thereby adjusting the height of clamp 112 above base 102 and the mounting surface.

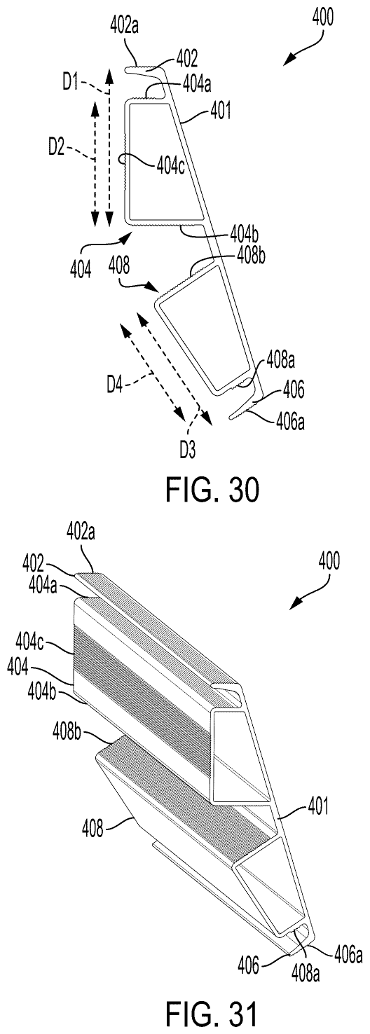

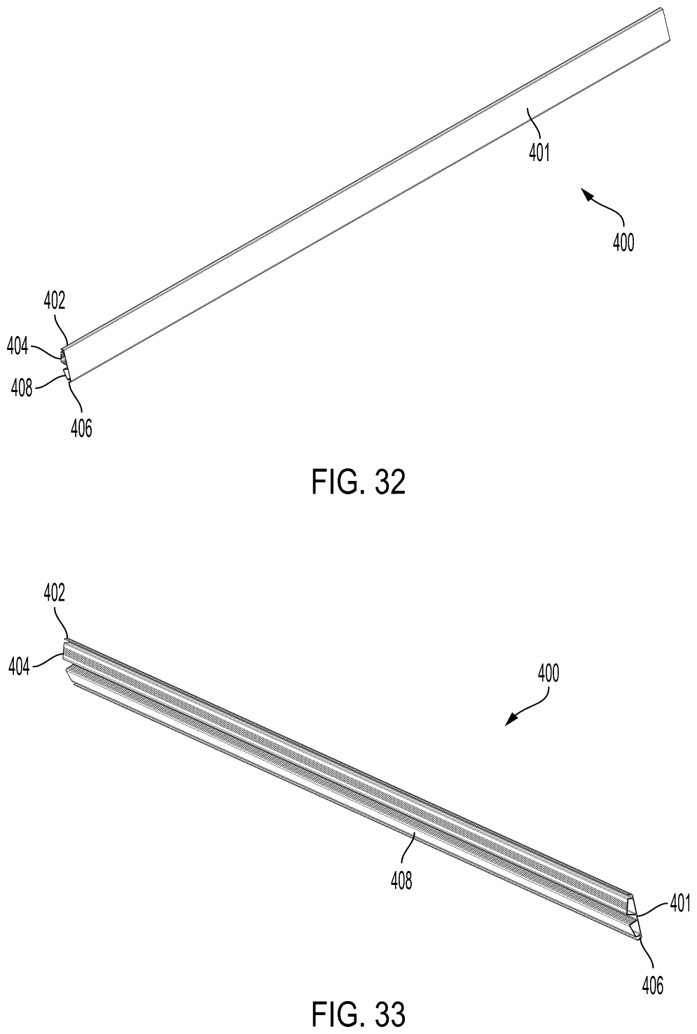

In some non-limiting embodiments, second support surface 120 may be configured to support a portion of a second solar panel (e.g., which may be the same as or similar to solar panel P shown in FIGS. 11 and 12). In some non-limiting embodiments, second support surface 120 may be configured to support a portion of a skirt (e.g., skirt 332 shown in FIGS. 30-33). In some non-limiting embodiments, second support surface 120 may include ridges.

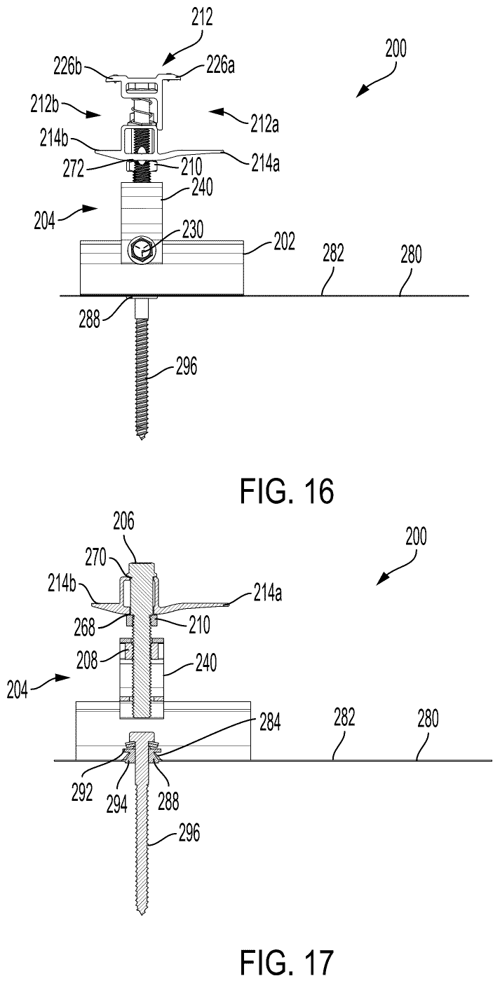

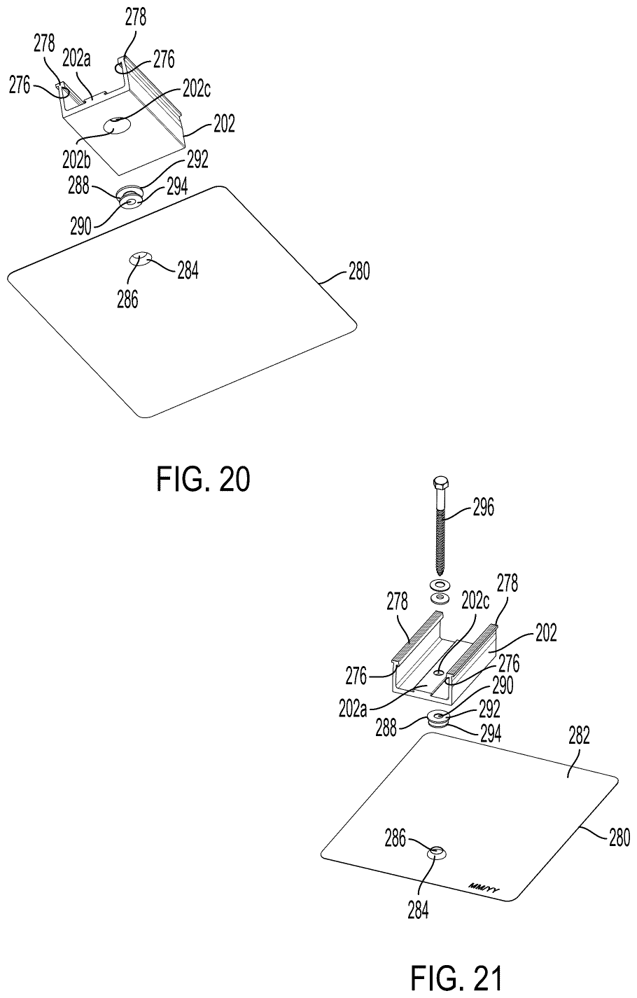

In some non-limiting embodiments, roof mount 100 may further include a flashing member (e.g., flashing member 280 shown in FIGS. 14-21) and base 102 may be installable to a roof over the flashing member.

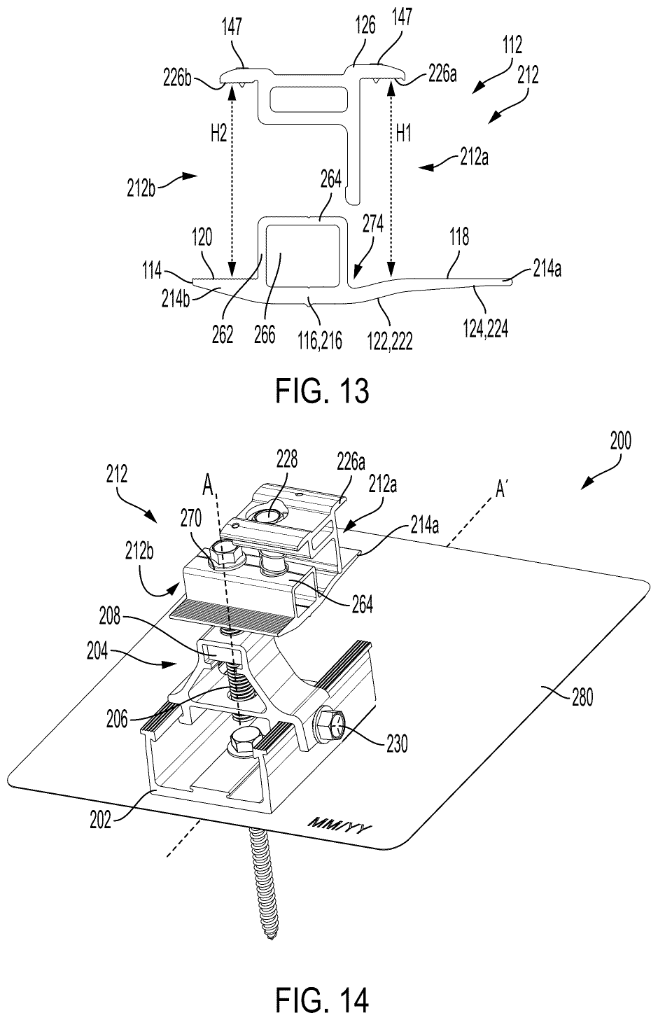

Referring now to FIGS. 13-21, FIGS. 13-21 are various views of roof mount 200 and features thereof according to some non-limiting embodiments of the present disclosure. Roof mount 200 may be the same as or similar to roof mount 100, where like parts are referred to with like reference numbers. In some non-limiting embodiments, roof mount 200 may include base 202 extending along second axis A′, and adjustment assembly 204 may be operatively coupled to base 202. Adjustment assembly 204 may include threaded shaft 206 extending along first axis A substantially perpendicular to second axis A′, adjustment nut 208 constrained within adjustment assembly 204, and support nut 210. Roof mount 200 may further include clamp 212 adjustably connected to base 202 by adjustment assembly 204, and a distance between clamp 212 and base 202 may be adjustable.

With continued reference to FIGS. 13-21, clamp 212 may include first channel 212a sized to receive and support a first solar panel (e.g., solar panel P as shown in FIGS. 11 and 12), and first channel 212a may be defined between first top flange 226a and first bottom flange 214a. First bottom flange 214a may include angled first portion 222 and substantially horizontal second portion 224. First channel 212a may have first height H1 extending between first top flange 226a and first bottom flange 214a, and first height H1 may be adjustable. In some non-limiting embodiments, an angled first portion 222 of first bottom flange 214a and at least one wall 262 may define a recess 274. Clamp 212 may further include second channel 212b sized to receive and support a skirt (e.g., skirt 600 shown in FIGS. 30-33) and may sized to receive and support a second solar panel (e.g., which may be the same as or similar to solar panel P shown in FIGS. 11 and 12). Second channel 212b may be defined between second top flange 226b and second bottom flange 214b. Second channel 212b may have a second height H2 extending between second top flange 226b and second bottom flange 214b, and second height H2 may be adjustable.

In exemplary embodiments, roof mount 200 may further include central portion 216 disposed between first bottom flange 214a and the second bottom flange 214b, and central portion 216 may include at least one wall 262 and horizontal portion 264 defining slot 266. In some non-limiting embodiments, roof mount 200 may also include first fastener 228 connected to clamp 212, and first fastener 228 may be operable to adjust first height H1 and second height H2. In some non-limiting embodiments, central portion 216 may be configured to receive adjustment assembly 204. In some non-limiting embodiments, central portion 216 may include through hole 268, and through hole 268 may be configured to receive adjustment assembly 204. In some non-limiting embodiments, horizontal portion 264 of central portion 216 may define mounting aperture 270 configured to receive adjustment assembly 204. In some non-limiting embodiments, central portion 216 may further include threaded aperture 272 configured to receive first fastener 228.

As further shown in FIGS. 14-19, in some non-limiting embodiments, adjustment assembly 204 may be slidable on base 202. In some non-limiting embodiments, roof mount 200 may further include slider fastener 230 configured to prevent adjustment assembly 204 from sliding relative to base 202.

With reference to FIG. 18, in some non-limiting embodiments, adjustment assembly 204 may include pedestal 240 operatively coupled to base 202. Pedestal 240 may receive partially threaded shaft 206, and adjustment nut 208 may be constrained within pedestal 240. In some non-limiting embodiments, pedestal 240 may include upper member 242, lower member 244 and two or more side members 246a, 246b defining open space 248. Pedestal 240 may further include first aperture 250 through upper member 242, and second aperture 252 through lower member 244, and first aperture 250 and second aperture 252 may be concentric with first axis A. First aperture 250 and second aperture 252 may be configured to receive partially threaded shaft 206.

As further shown in FIG. 18, in some non-limiting embodiments, pedestal 240 may include first ledge 254a and second ledge 254b. First ledge 254a and second ledge 254b and upper member 242 may be configured to constrain adjustment nut 208 within pedestal 240. In some non-limiting embodiments, two or more side members 246a, 246b and partially threaded shaft 206 may be configured to horizontally constrain adjustment nut 208 within pedestal 204. In some non-limiting embodiments, two or more side members 246a, 246b may be configured to rotationally constrain adjustment nut 208 within pedestal 240, such that two or more sidewalls 246a, 246b prevent rotation of adjustment nut 208.

With continued reference to FIG. 18, in some non-limiting embodiments, pedestal 240 may include first catch 256 extending from lower member 244 and first side member 246a, and second catch 258 extending from lower member 244 and second side member 246b. In some non-limiting embodiments, first catch 256 and second catch 258 may each define groove 276 configured to slidingly couple to top flange 278 of base 202, and first catch 256 and second catch 258 may be slidingly engaged with base 202. In some non-limiting embodiments, pedestal 240 may include pedestal arm 260 extending from second catch 258. In some non-limiting embodiments, pedestal arm 260 may include aperture 262 configured to receive slider fastener 230. Slider fastener 230 may be configured to prevent adjustment assembly 204 from sliding relative to base 202.

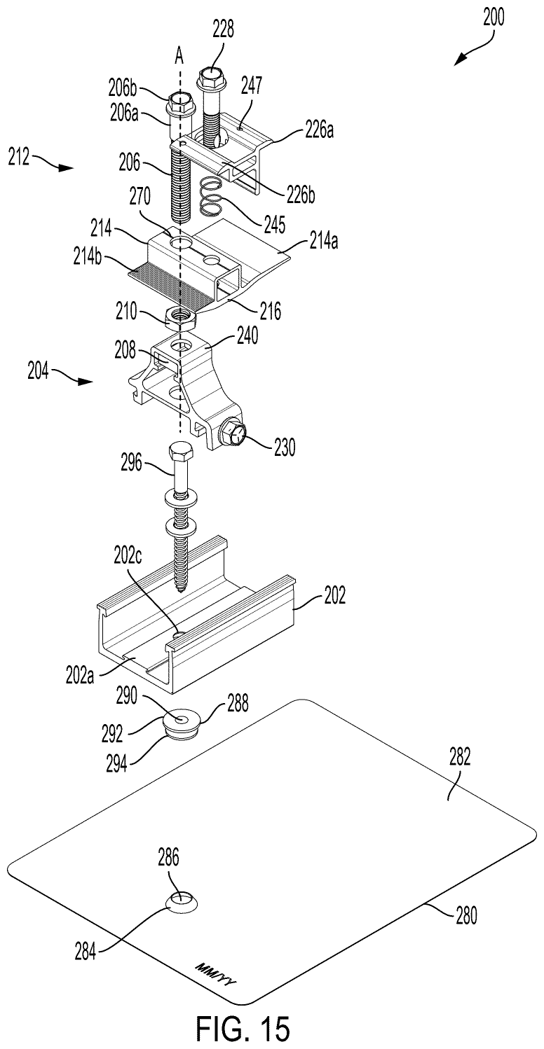

As shown in FIGS. 14-21, in some non-limiting embodiments, support nut 110 may be coupled to partially threaded shaft 206 below non-threaded portion 206a (e.g., non-threaded portion 206a shown in FIG. 15) of partially threaded shaft 206 such that support nut 210 is configured to rotate with partially threaded shaft 206. Support nut 210 may be configured to contact and support central portion 216 of lower clamp portion 214 such that clamp 212 is supported above adjustment assembly 204. In some non-limiting embodiments, a top of lower clamp portion 214 may be contacted by drive head 206b of partially threaded shaft 206 such that partially threaded shaft 206 and support nut 210 are configured to rotate with respect to adjustment nut 208 and independently of lower clamp portion 214.

In some non-limiting embodiments, drive head 206b may sit above the top surface of horizontal portion 264 and support nut 210 may sit below and support the bottom surface of central portion 216, and partially threaded shaft 206 may be received within mounting aperture 270 and through hole 268 which may be unthreaded clearance apertures. The distance between the bottom of drive head 206b and the top of support nut 210 may be greater than the height of the central portion 216 of first clamp portion 214 from the bottom surface of central portion 216 to the top surface of horizontal portion 264. This exemplary configuration may allow partially threaded shaft 206 to rotate freely within first clamp portion 214 and for a drill or other tool to move partially threaded shaft 206 up and down within adjustment nut 208 without rotating clamp 212 and thereby adjusting the height of clamp 212 above base 202 and the mounting surface.

In some non-limiting embodiments, second channel 212b may be configured to receive and support a portion of a second solar panel (e.g., which may be the same as or similar to solar panel P shown in FIGS. 11 and 12). In some non-limiting embodiments, second channel 212b may be configured to support a portion of a skirt (e.g., skirt 332 shown in FIGS. 30-33).

With continued reference to FIGS. 14-21, in some non-limiting embodiments, roof mount 200 may further include a flashing member 280 and base 202 may be installable to a roof over flashing member 280. In some non-limiting embodiments, flashing member 280 may include substantially flat portion 282, raised portion 284 protruding from substantially flat portion 282, and aperture 286. In some non-limiting embodiments, aperture 286 may be concentric with raised portion 284 and may extend through flashing member 280.

In some non-limiting embodiments, roof mount 200 may further include gasket 288 and gasket 288 may be configured to engage with raised portion 284 and aperture 286. In exemplary embodiments, gasket 288 may include through hole 290, cylindrical upper portion 292 extending above raised portion 284, and frustoconical lower portion 294 engaged with an inner surface of the raised portion.

In some non-limiting embodiments, base 202 and flashing member 280 may be fastened to the roof with threaded fastener 296 extending through base 202, gasket 288, and raised portion 284 of flashing member. In some non-limiting embodiments, base 202 may include a raised central portion 202a and a recess 202b extending from a bottom surface of base 202 into raised central portion 202a. In exemplary embodiments, recess 202b may be configured to receive raised portion 284 of flashing member 280. In some non-limiting embodiments, recess 202b may also be configured to receive gasket 288. In some non-limiting embodiments, bases 202 may include base aperture 202c extending through raised central portion 202a and recess 202b. In exemplary embodiments, base aperture 202c may be configured to receive threaded fastener 296.

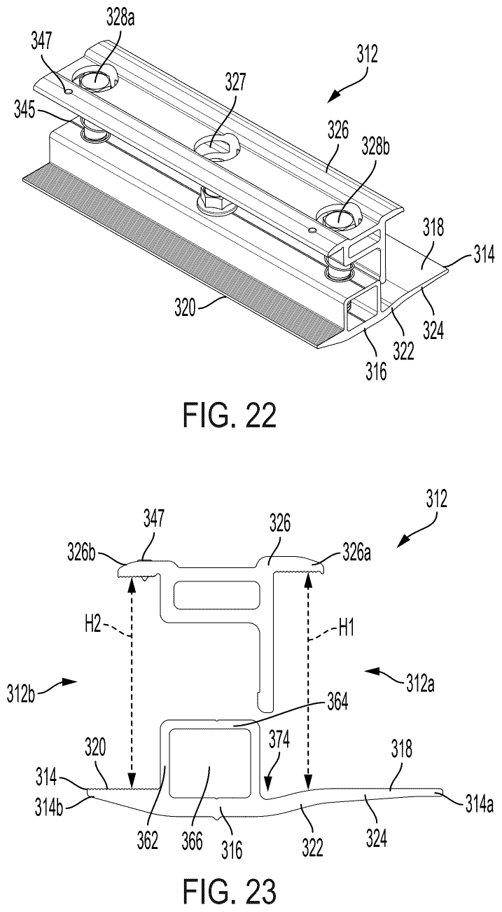

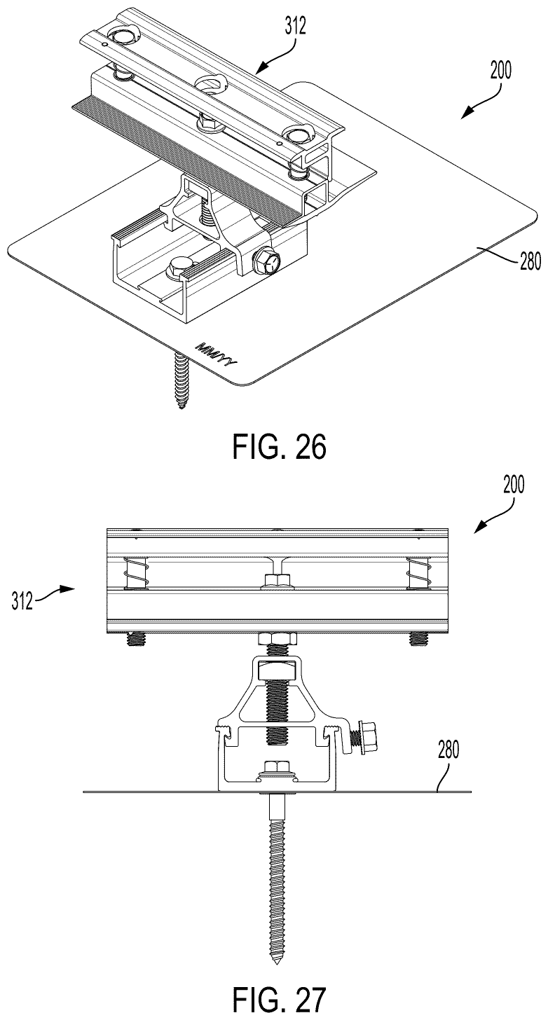

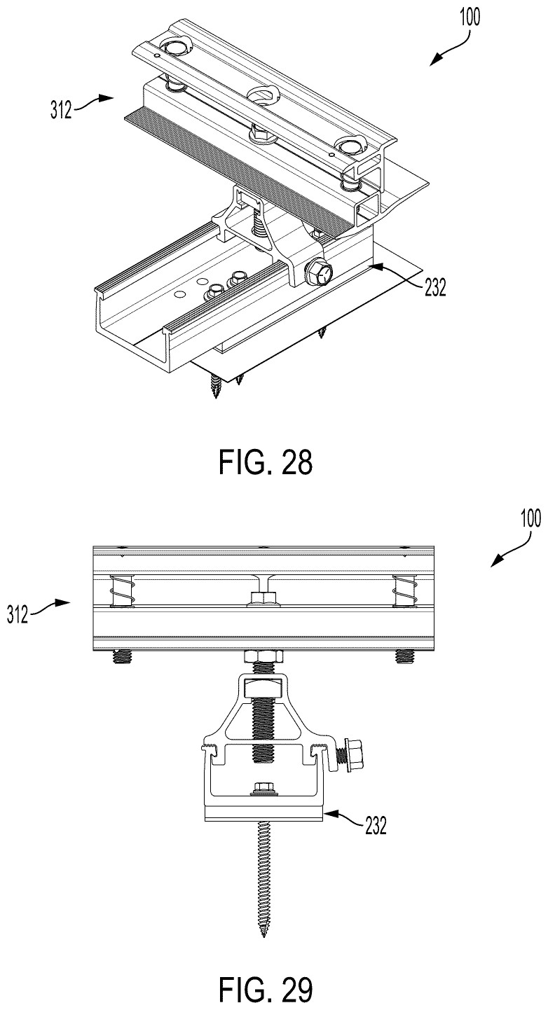

Referring now to FIGS. 22-29 in some non-limiting embodiments, roof mount 100, 200 may include clamp 312 which may be the same as or similar to clamp 312 and/or clamp 212, where like parts are referred to with like reference numbers. Clamp 312 may include first clamp portion 314 having central portion 316, first support surface 318 and second support surface 320. First support surface 318 may include angled first portion 322 and substantially horizontal second portion 324, and first support surface 318 may be configured to support a portion of a first solar panel (e.g., solar panel P as shown in FIGS. 11 and 12). Central portion 316 may be disposed between first support surface 318 and second support surface 320. In some non-limiting embodiments, central portion 316 may define aperture 338 configured to receive adjustment assembly 304. Clamp 312 may further include second clamp portion 326.

In exemplary embodiments, clamp 312 may be longer than the clamp of other non-limiting embodiments such as clamp 112 and/or clamp 212. As shown in FIGS. 22 and 24-29, clamp 312 may further include access 327 defined through second clamp portion 326. In some non-limiting embodiments, access 327 may provide access to adjustment assembly 304, and in particular, to partially threaded shaft 306, and more particularly, to the drive head 306b of partially threaded shaft 306. In this way, adjustment assembly 304 may be adjusted from above second clamp portion 326. In exemplary embodiments, clamp 312 may further include second fastener 328b connected to clamp 312, and second fastener 328b may be operable to tighten second clamp portion 326 to first clamp portion 314. In some non-limiting embodiments, access 327 may be defined between first fastener 328a and second fastener 328b, and first fastener 328a and second fastener 328b may be positioned at opposite ends of clamp 312. In some non-limiting embodiments, first fastener 328a and second fastener 328b may be received within fastener through holes in second clamp portion 326 and threaded apertures in first clamp portion 314 to allow tightening of second clamp portion 326 to first clamp portion 314. In some non-limiting embodiments, second clamp portion 326 may further include counterbore access that allow the heads of first fastener 328a and second fastener 328b to be recessed into second clamp portion 326 when first fastener 328a and second fastener 328b are tightened.

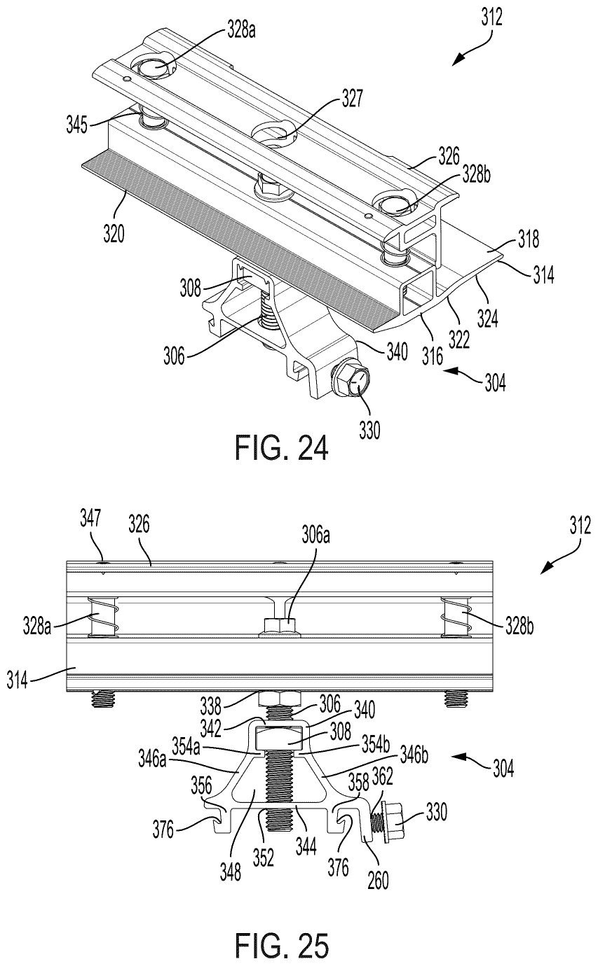

In some non-limiting embodiments, clamp 312 may be a bridge clamp or a coupling, such that first support surface 318 is configured to support a portion of one or more solar panels and second support surface 320 is configured to support a portion of one or more solar panels at the same time. For example, clamp 312 may be used as a bridge clamp as part of a mounting system or solar panel array to bridge the gap between roof mounts such as roof mount 100, 200. In exemplary embodiments, clamp 312 may be provided without the base and/or without adjustment assembly and the associated components thereof. In exemplary embodiments, clamp 312 may support the solar panels coupled thereto and be supported above the roof by the solar panels coupled thereto. As shown in FIGS. 24-29, in some non-limiting embodiments, clamp 312 may be implemented in a roof mount such as roof mount 100 and/or roof mount 200, as described herein.

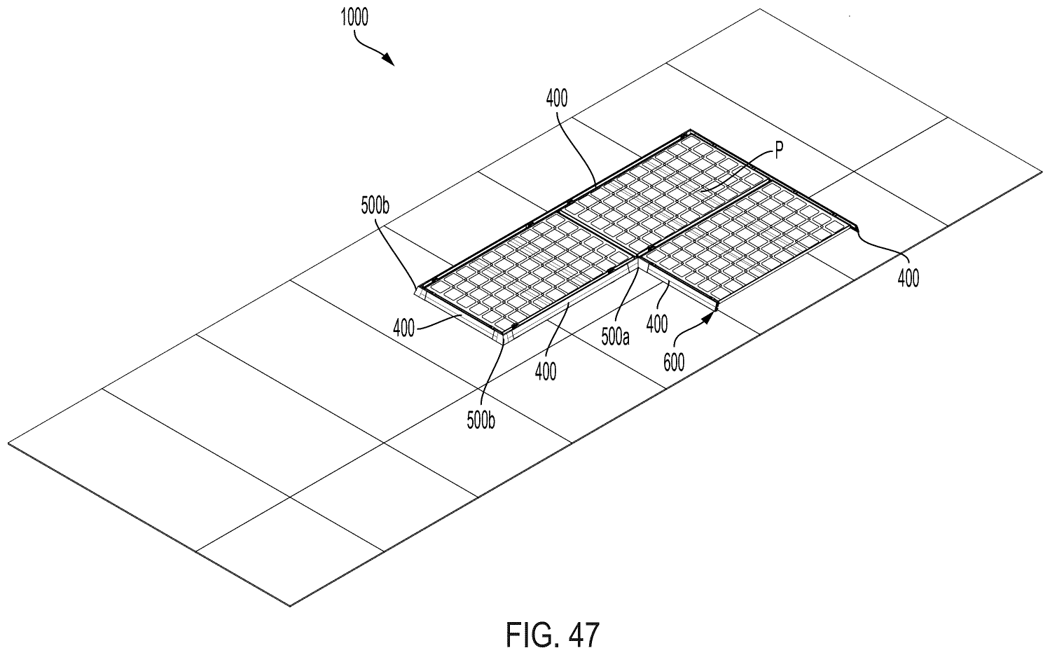

Referring now to FIGS. 30-47, FIGS. 30-47 are various views of roof mounting system 1000 and features thereof according to some non-limiting embodiments of the present disclosure. As shown in FIGS. 30-47, roof mounting system 1000 may include at least one roof mount, which may be the same as or similar to roof mount 100 and/or roof mount 200 as described herein.

For example, a roof mount of roof mounting system 1000 may include a base installable on a roof an adjustment assembly operatively coupled to the base. The adjustment assembly may include a partially threaded shaft extending along a first axis substantially perpendicular to the roof, an adjustment nut which may be constrained within the adjustment assembly, and a support nut. A clamp may be adjustably connected to the base by the adjustment assembly, and a distance between the clamp and the base may be adjustable. The clamp may include a first clamp portion having a central portion, a first support surface and a second support surface. The first support surface may include an angled first portion and a substantially horizontal second portion and the first support surface may be configured to support a portion of a first solar panel. The central portion may be disposed between the first support surface and the second support surface. The clamp may further include a second clamp portion. The roof mount may also include a fastener connected to the clamp, and the fastener may be operable to tighten the second clamp portion to the first clamp portion.

With reference to FIGS. 30-33, in some non-limiting embodiments, roof mounting system 1000 may include skirt 400. Skirt 400 may include elongate face 401, first protrusion 402, first hollow body 404, second protrusion 406, and second hollow body 408.

In some non-limiting embodiments, skirt 400 may be reversible such that it can be installed in two orientations. In a first orientation, first protrusion 402 may be at the top and second protrusion 406 may be at the bottom when skirt 400 is installed in a roof mount. In a second orientation, first protrusion 402 may be at the bottom and second protrusion 406 may be at the top when skirt 400 is installed in a roof mount.

In some non-limiting embodiments, skirt 400, first protrusion 402, first hollow body 404, second protrusion 406, and second hollow body 408 may be sized and configured to be installed in multiple configurations to allow for use with roof mounting system 1000 for installing solar panels with different heights or thicknesses. For example, the distance between surface 402a of first protrusion 402 and second surface 404b of first hollow body 404 may be a first distance D1, the distance between first surface 404a and second surface 404b of first hollow body 404 may be a second distance D2, the distance between second surface 408b of second hollow body 408 and surface 406a of second protrusion 406 may be a third distance D3, and a distance between second surface 408b and first surface 408a of second hollow body 408 may be a fourth distance D4. In some non-limiting embodiments, D1, D2, D3, and D4 may correspond to different solar panel heights or thickness. For example, D1 may be 40 mm and correspond to a solar panel with a 40 mm thickness, D2 may be 32 mm and correspond to a solar panel with a 32 mm thickness, D3 may be 35 mm and correspond to a solar panel with a 35 mm thickness, and D4 may be 30 mm and correspond to a solar panel with a 30 mm thickness.

In some non-limiting embodiments of roof mounting system 1000, first protrusion 402 and first hollow body 404 of skirt 400 may be received and supported by the second support surface and the second clamp portion of the roof mount. In some non-limiting embodiments, first hollow body 404 of skirt 400 may be received and supported by the second support surface and the second clamp portion of the roof mount. In some non-limiting embodiments, second protrusion 406 and second hollow body 408 of skirt 400 may be received and supported by the second support surface and the second clamp portion of the roof mount. In some non-limiting embodiments, second hollow body 408 of skirt 400 may be received and supported by the second support surface and the second clamp portion of the roof mount. Thus, there are various ways in which the second support surface and the second clamp portion of the roof mount may together exert a clamping force on skirt 400 to clamp skirt 400.

In some non-limiting embodiments, the second support surface of the roof mount and a clamping surface of the roof mount may each include ridges. In some non-limiting embodiments, surface 402a of first protrusion 402 may include ridges. In some non-limiting embodiments, first surface 404a, second surface 404b, and third surface 404c of first hollow body 404 may each include ridges. In some non-limiting embodiments, surface 406a of second protrusion 406 may include ridges. In some non-limiting embodiments, first surface 408a and second surface 408b of second hollow body 408 may include ridges. In some non-limiting embodiments, the ridges of the clamping surface of the second clamp portion may mate with the ridges of either surface 402a of first protrusion 402, first surface 404a of first hollow body 404, surface 406a of second protrusion 406, or first surface 408a of second hollow body 408 when skirt 404 is received and supported by the second support surface and the second clamp portion. In some non-limiting embodiments, the ridges of the second support surface may mate with the ridges of either second surface 404b of first hollow body 404 or second surface 408b of second hollow body 408 when skirt 404 is received and supported by the second support surface and the second clamp portion. In some non-limiting embodiments, the ridges of third surface 404c of first hollow body 404 may be identifying ridges that identify which orientation of the skirt is appropriate for use and which surfaces should be clamped in the roof mount to correspond to the thickness of the solar panels being installed. In some non-limiting embodiments, the ridges of third surface 404c of first hollow body 404 may be felt or seen by an installer along the entire length of skirt 400.

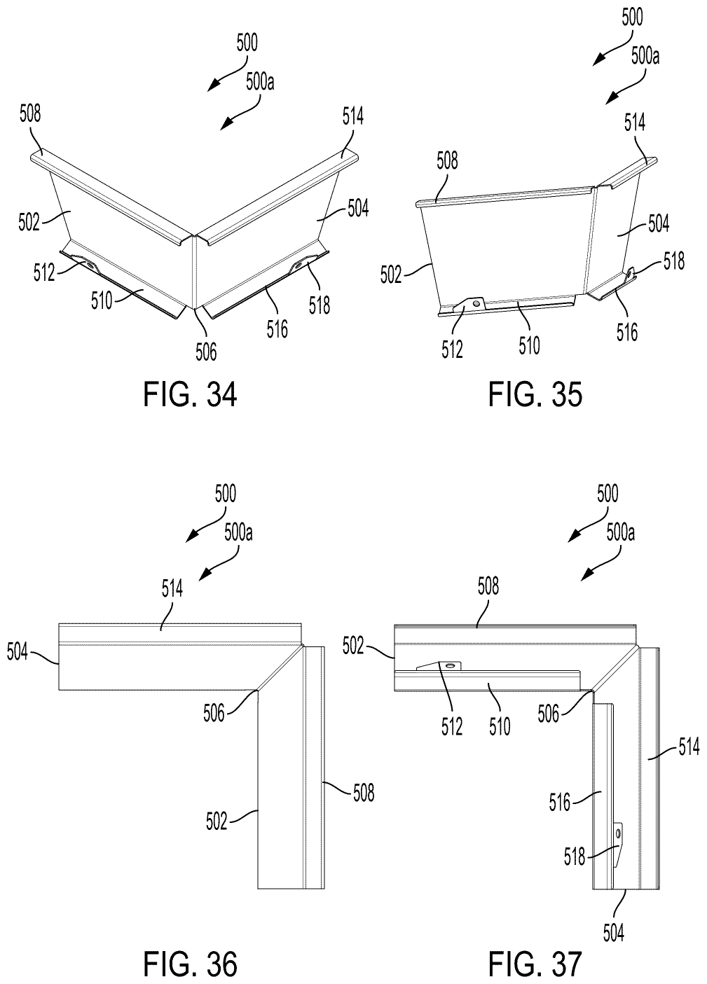

In some non-limiting embodiments, roof mounting system 1000 may further include at least one corner cover 500 (e.g., interior corner cover 500a and/or exterior corner cover 500b) as shown in FIGS. 34-41. In some non-limiting embodiments, corner cover 500 may include first portion 502 and second portion 504 connected at corner joint 506. In some non-limiting embodiments, corner cover 500 may include first flange 508 extending from the top of first portion 502 and second flange 510 extending from the bottom of first portion 502. In some non-limiting embodiments, second flange 510 may have a first lower tab 512. In some non-limiting embodiments, corner cover 500 may further include third flange 514 extending from the top of second portion 504 and fourth flange 516 extending from the bottom of second portion 504. In some non-limiting embodiments, fourth flange 516 may include second lower tab 518. In some non-limiting embodiments, corner cover 500 may be configured to snap over a corner of roof mounting system 1000 where two skirts 400 meet, after the two skirts 400 have been installed.

In some non-limiting embodiments, roof mounting system 1000 may include at least one corner cover 500 where corner cover 500 is an interior corner cover 500a, as shown in FIGS. 34-37, such that first flange 508, second flange 510, third flange 514, and fourth flange 516 extend perpendicularly away from each other and clip to a first and second skirt 400.

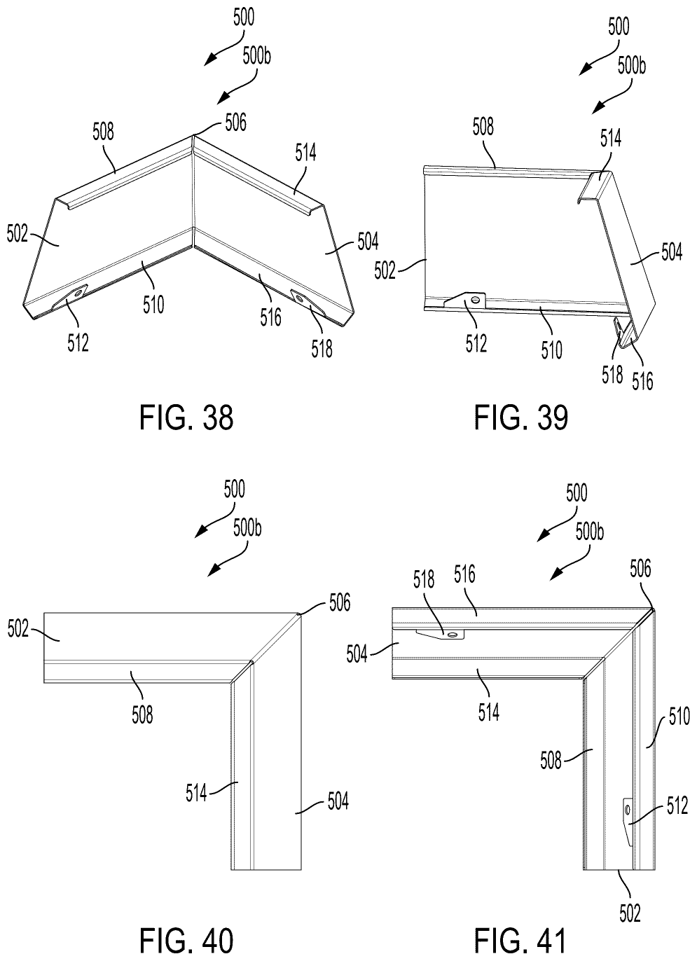

In some non-limiting embodiments, roof mounting system 1000 may include at least one corner cover 500 where corner cover 500 is an exterior corner cover 500b, as shown in FIGS. 38-41, such that first flange 508, second flange 510, third flange 514, and fourth flange 516 extend perpendicularly toward each other and clip to a first and second skirt 400.

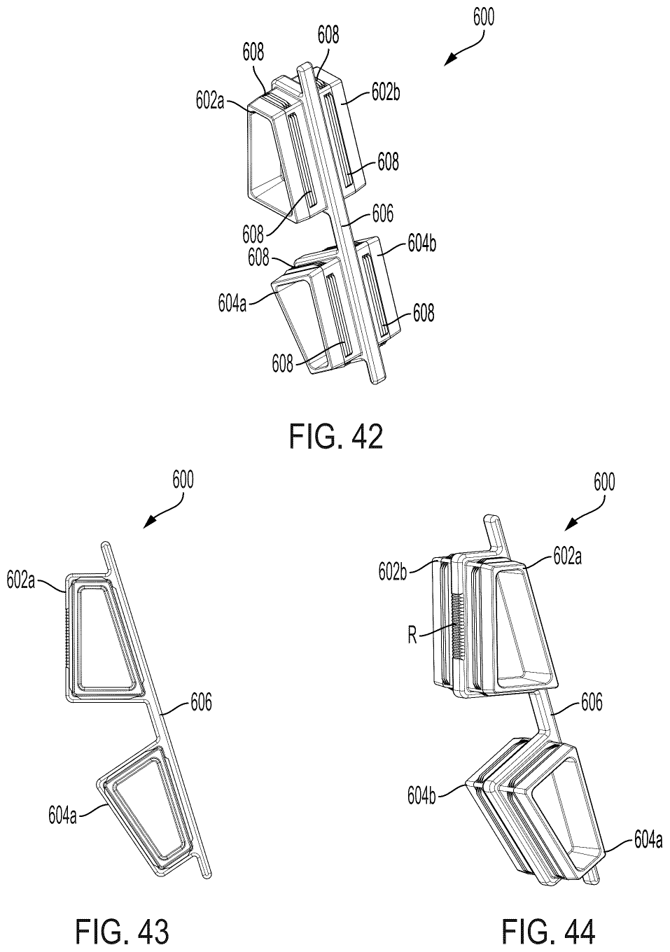

In some non-limiting embodiments, roof mounting system 1000 may include at least one cap 600, as show in FIGS. 42-44. In some non-limiting embodiments, each cap 600 may include a pair of upper inserts 602a, 602b configured to mate with first hollow body 404 of at least one skirt 400 and a pair of lower inserts 604a, 604b configured to mate with second hollow body 804 of at least one skirt 400. In some non-limiting embodiments, cap 600 may further include face connector 606 connecting the pair of upper inserts 602a, 602b and the pair of lower inserts 604a, 604b.

In some non-limiting embodiments, at least one cap 600 may be received by an end of a first skirt 400 such that first hollow body 404 of skirt 400 receives an upper insert of the pair of upper inserts 602a, 602b and second hollow body 408 of first skirt 404 receives a lower insert of the pair of lower inserts 604a, 604b such that face connecter 606 is coplanar with elongate face 401 of first skirt 400. In some exemplary embodiments where cap 600 is only connected to one end of one skirt, cap 600 may be an end cap.

In some non-limiting embodiments, at least one cap 600 may further be received by an end of second skirt 400 such that first hollow body 404 of second skirt 400 receives an upper insert of the pair of upper inserts 602a, 602b and second hollow body 408 of second skirt 404 receives a lower insert of the pair of lower inserts 604a, 604b such that elongate face 401 of first skirt 404 and elongate face of second skirt 404 are held coplanar to each other and to face connecter 606. In some exemplary embodiments where cap 600 is connected to one end of a first skirt and one end of a second skirt, cap 600 may be a skirt splice.

In some non-limiting embodiments, similar to skirt 400, cap 600 may be reversible such that it can be installed in two orientations. In a first orientation, the pair of upper inserts 602a, 602b may be at the top and the pair of lower inserts 604a, 604b may be at the bottom when installed in skirt 400 when skirt 400 is in a first orientation. In a second orientation, the pair of upper inserts 602a, 602b may be at the bottom and the pair of lower inserts 604a, 604b may be at the top when installed in skirt 400 when skirt 400 is in a second orientation. In exemplary embodiments, the pair of upper inserts 602a, 602b and the pair of lower inserts 604a, 604b may include fingers 608 configured to provide additional friction for holding cap 600 in at least one skirt 400. In some non-limiting embodiments, a rear portion of face connector 606 between the pair of upper inserts 602a, 602b may include ridges R that correspond to the ridges of surface 404c of first hollow body 404 of skirt 404. In exemplary embodiments, these ridges of cap 600 may indicate which pair of inserts 602a, 602b, 604a, 604b correspond to which hollow body 404, 408. For example, the upper pair of inserts 602a, 602b may always correspond to first hollow body 404.

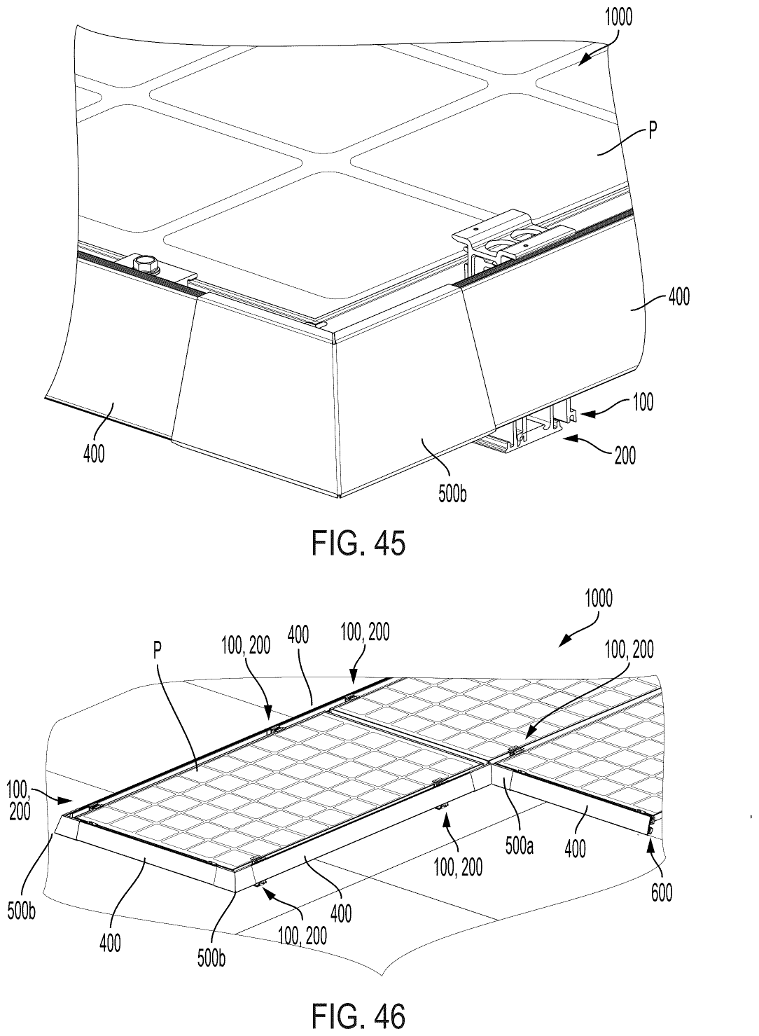

FIGS. 45-47 show a portion of roof mounting system 1000 implemented in a solar array according to some non-limiting embodiments of the present disclosure. As shown in FIGS. 45 and 46, roof mounting system 1000 may include several solar panels P, roof mounts 100, 200, skirts 404, and corner covers 500.

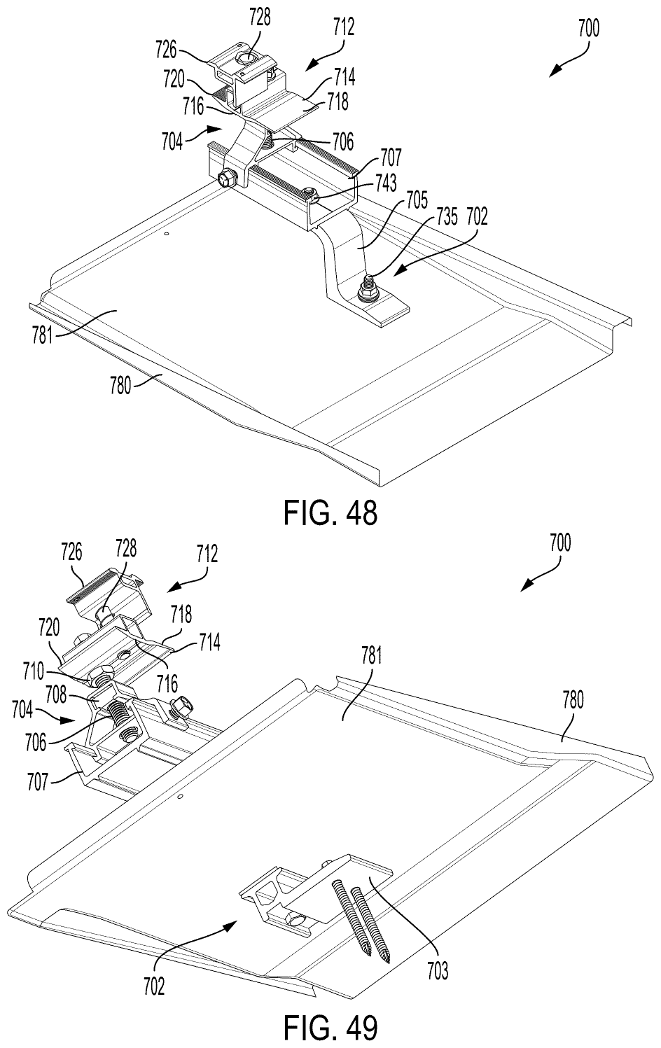

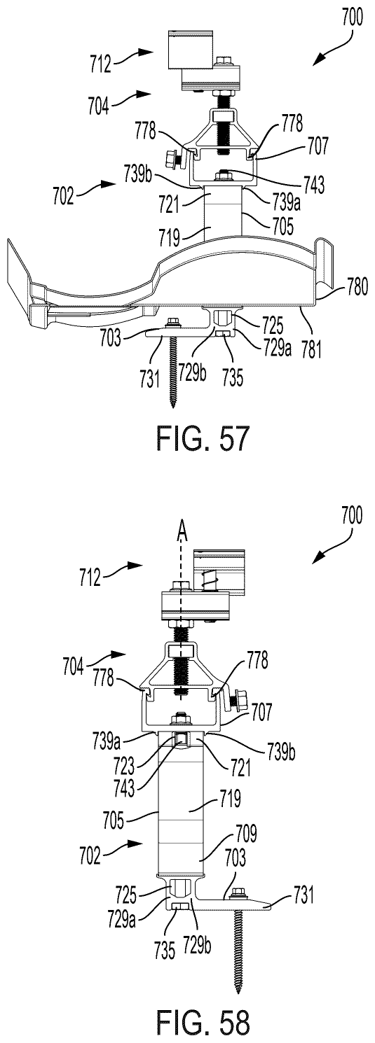

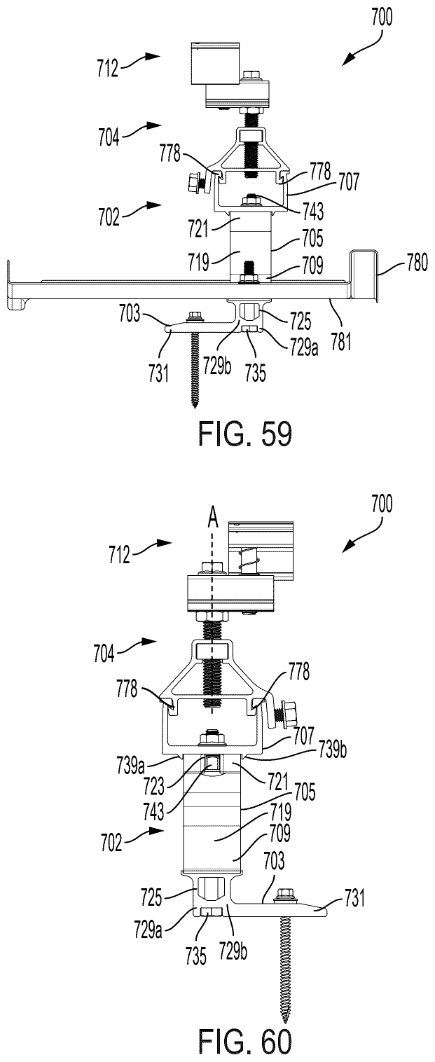

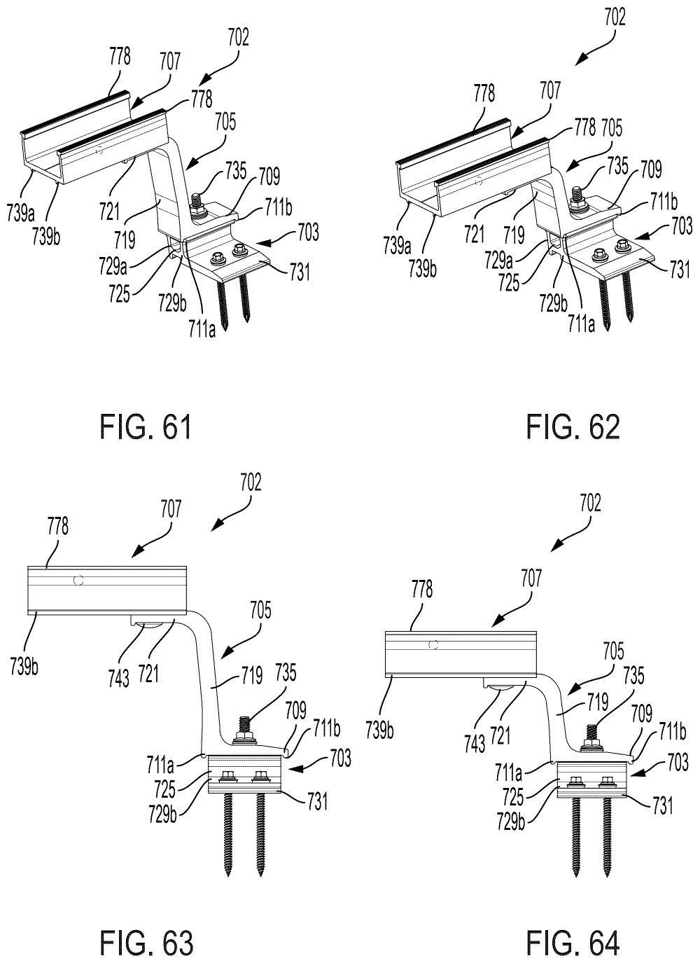

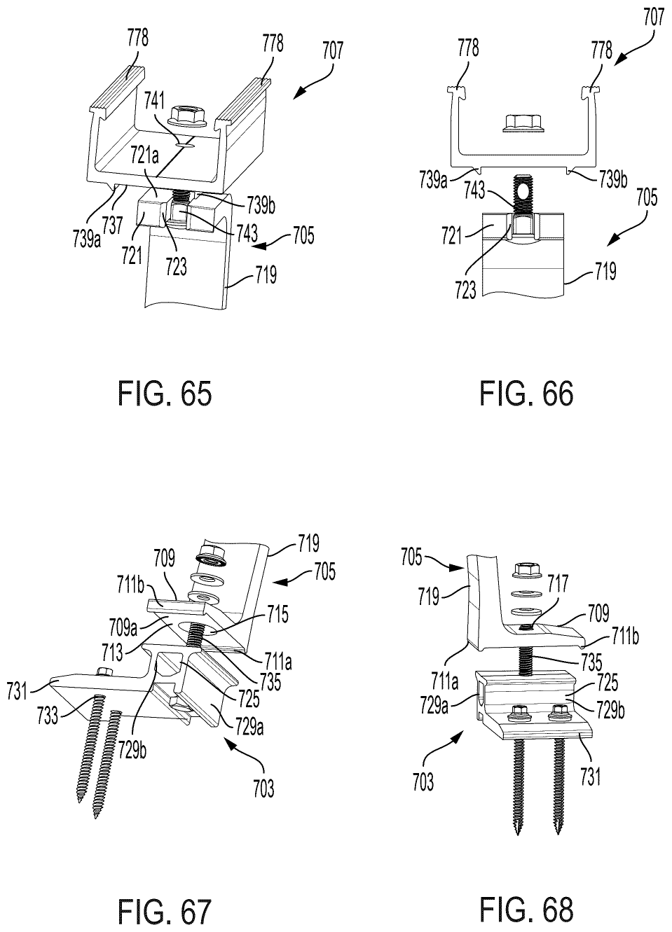

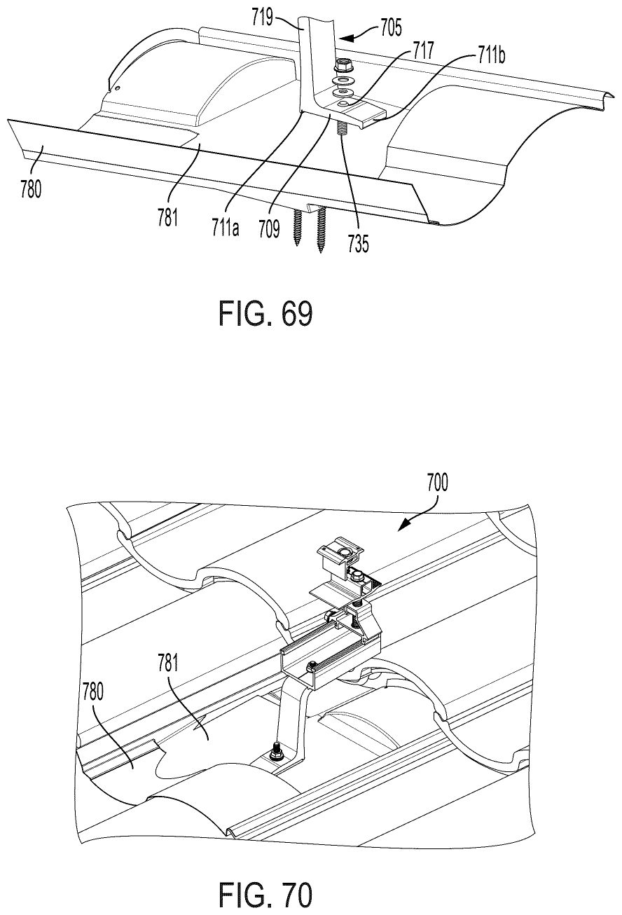

Referring now to FIGS. 48-70, FIGS. 48-70 are various views of roof mount 700 and features thereof according to some non-limiting embodiments of the present disclosure. Roof mount 700 may be the same as or similar to roof mount 100 and/or roof mount 200, where like parts are referred to with like reference numbers. As shown in the figures, roof mount 700 may include base assembly 702 installable on a roof, and base assembly 702 may include foot 703, arm 705, and slider 707. Roof mount 700 may further include flashing 780 positioned between foot 703 and arm 705, and adjustment assembly 704 operatively coupled to slider 707. Adjustment assembly 707 may include partially threaded shaft 706 extending along first axis (e.g., first axis A as shown in FIGS. 58 and 60), which may be substantially perpendicular to the roof. Adjustment assembly 704 may further include adjustment nut 708 constrained within adjustment assembly 704, and support nut 710. Clamp 712 may be adjustably connected to base assembly 702 by adjustment assembly 704, and a distance between clamp 712 and slider 703 may be adjustable. Clamp 712 may include first clamp portion 714 having central portion 716, first support surface 718 and second support surface 720. Central portion 716 may be disposed between first support surface 718 and second support surface 720. Clamp 712 may further include second clamp portion 726. Roof mount 700 may also include fastener 728 connected to clamp 712, and fastener 728 may be operable to tighten second clamp portion 726 to first clamp portion 714.

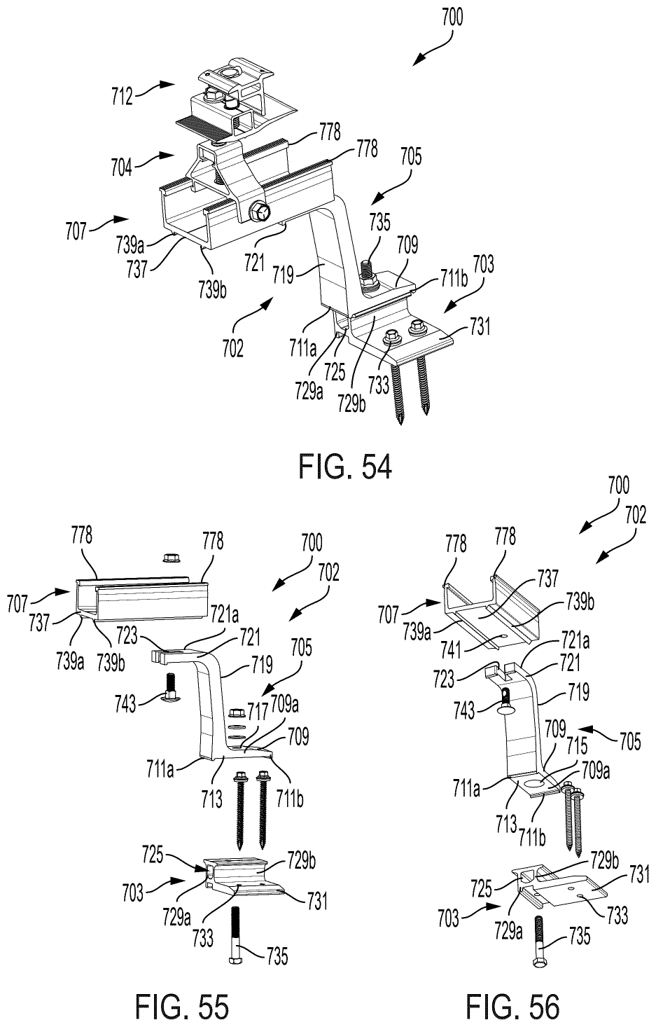

In some non-limiting embodiments, as shown in FIGS. 54-64, arm 705 may include lower horizontal portion 709 including two downwardly extending lips 711a, 711b protruding from bottom surface 713. Foot 703 may further include recess 715 extending into bottom surface 713 and aperture 717 extending through bottom surface 713 and recess 715 between lips 711a, 711b. In some non-limiting embodiments, arm 705 may further include upstanding portion 719 and upper horizontal portion 721 extending from upstanding portion 719. In some non-limiting embodiments, upper horizontal portion 721 may include a slot 723.

In some non-limiting embodiments, arm 705 may include an offset Z shape, such that lower horizontal portion 709 and upstanding portion 719 may define an obtuse angle, upstanding portion 719 and upper horizontal portion 721 may define an obtuse angle, and top horizontal surface 721a and bottom horizontal surface 709a may be parallel.

In some non-limiting embodiments, foot 703 may include hollow raised portion 725 having opposing flanges 727a, 727b extending from the top of foot 703 in opposite directions. In some non-limiting embodiments, foot 703 may further include two vertical walls 729a, 729b forming hollow raised portion 725. In some non-limiting embodiments, bottom flange 731 may extend from a bottom of one of two vertical walls 729a, 729b and bottom flange 731 may have at least one aperture 733. Foot 703 may further include first threaded stud 735 extending from recess 715 through hollow raised portion 725 and out of the top of foot 703.

In some non-limiting embodiments, slider 707 may include two opposed upstanding slider members 778 extending from slider base 737. Slider members 778 may be configured to slidably engage with adjustment assembly 704. In some non-limiting embodiments, slider 707 may further include two elongated base protrusions 739a, 739b extending from a bottom surface of slider base 737 and a slider aperture 741 extending through slider base 737 and configured to receive second threaded stud 743. In some non-limiting embodiments, second threaded stud 743 extends through slider aperture 741 and the slot 723 of arm 705 to fasten slider 707 to arm 705. In some non-limiting embodiments, second threaded stud may have a collar for engaging with slot 723. Ise the collar may be sized and configured to engage with slot 723. For example, the collar may be square or second threaded stud 743 may be a carriage bolt. In some non-limiting embodiments, first threaded stud 735 may pierce and extend through flashing 780, and first threaded stud 735 may operatively couple arm 705 to foot 703.

In some non-limiting embodiments, flashing 780 may include a substantially flat portion 781, which may be pierceable by first threaded stud 735. In some non-limiting embodiments, substantially flat portion 781 may be configured to be supported by foot 703 and may be configured to support arm 705. In some non-limiting embodiments, flashing 780 may be monolithically formed.

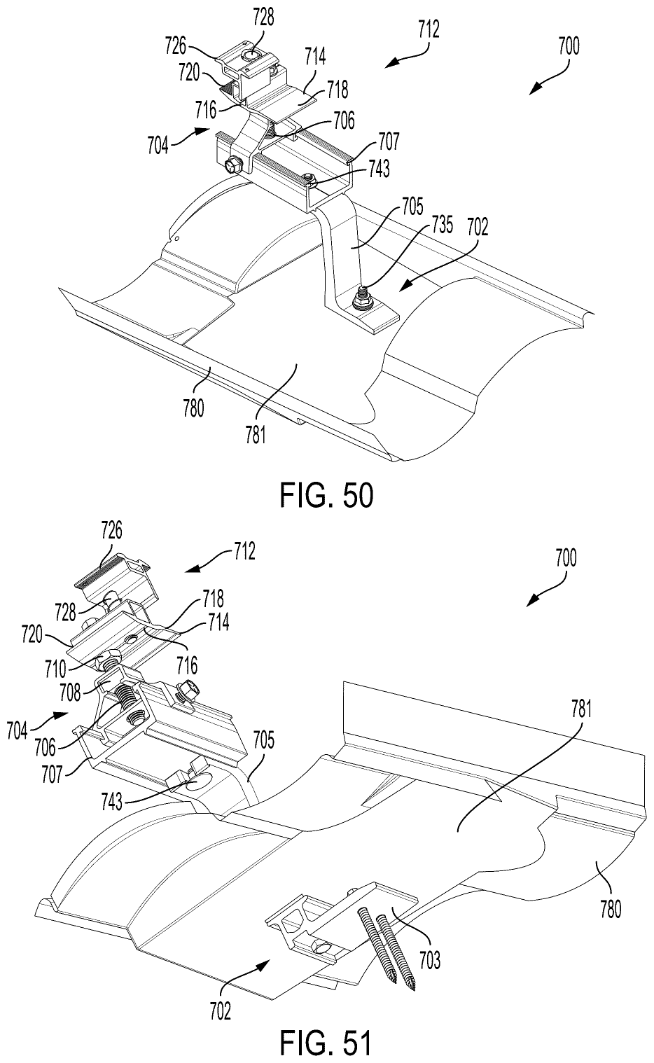

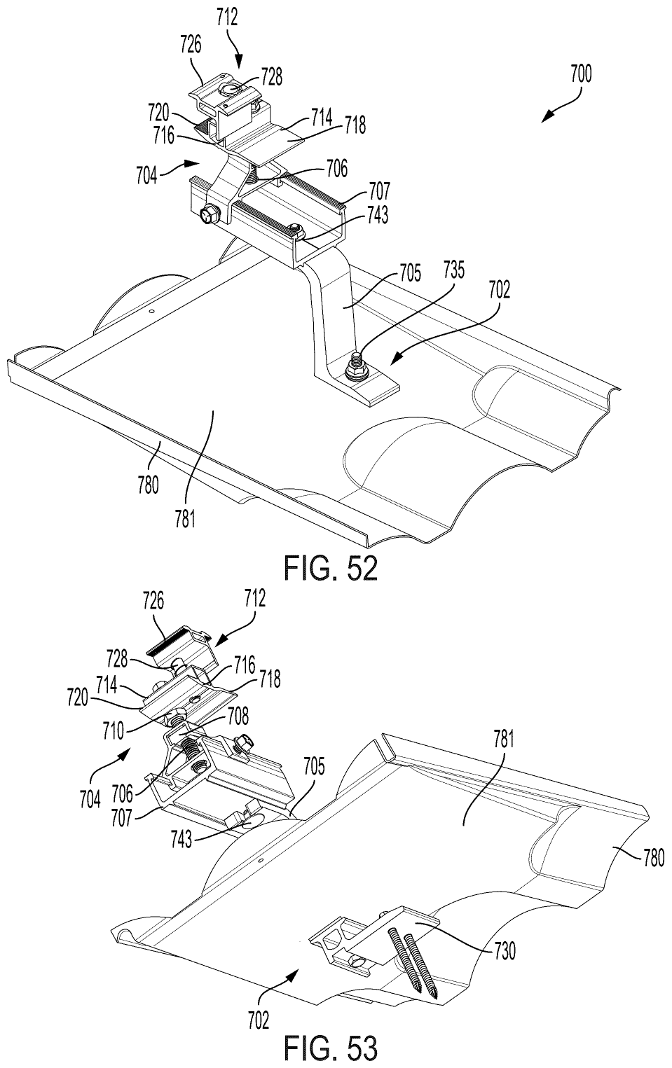

As shown in FIGS. 48, 49, and 59, in some non-limiting embodiments, flashing 780 may include a substantially flat shape and may be configured to replace a flat roof tile. As shown in FIGS. 50, 51, 57, and 69-71, flashing 780 may include an S shape and may be configured to replace an S shaped roof tile. As shown in FIGS. 52 and 53, flashing 70 may include a W shape and may be configured to replace a W shaped roof tile.

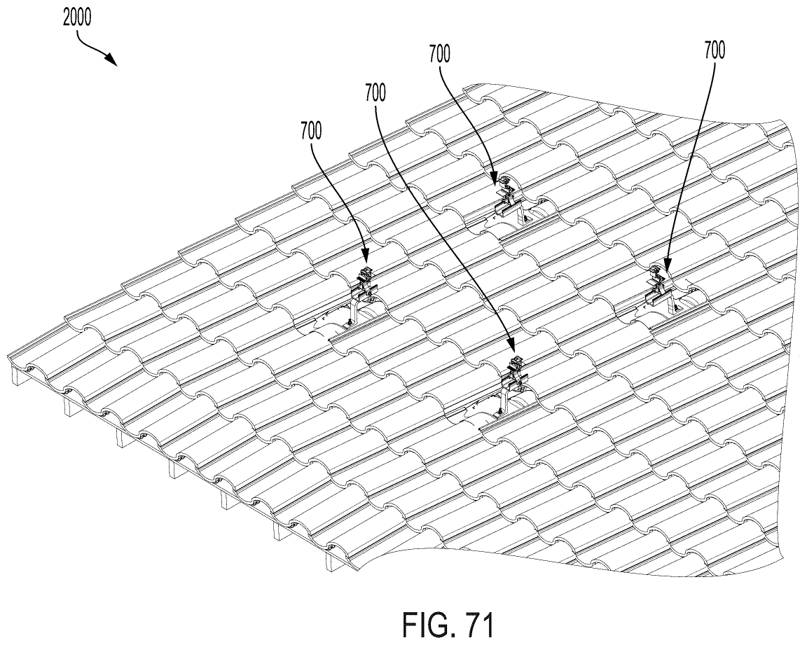

Referring now to FIGS. 70 and 71, FIG. 70 shows an implementation of roof mount 700 according to some non-limiting embodiments of the present disclosure, and FIG. 71 shows a portion of roof mounting system 2000 implemented on a roof according to some non-limiting embodiments of the present disclosure. Roof mounting system 2000 may be the same as or similar to roof mounting system 1000. As shown in FIG. 71, roof mounting system 2000 may include at least one roof mount 700 as described herein. Further, in exemplary embodiments, the one or more roof mount 700 may include a clamp as described herein, such as clamp 712, clamp 112, clamp 212, and/or clamp 312. In some non-limiting embodiments, although not shown in FIG. 71, roof mounting system 2000 may further include at least one skirt such as skirt 400, at least one corner cover such as corner cover 500, 500a, 500b, and/or at least one cap such as cap 600.

It is to be understood, that while the embodiments of the present disclosure have been described with respect to mounting devices, assemblies, and methods for mounting at least one object above a roof surface, and specifically to a height adjustment roof mounting system for securely and adjustably mounting one or more objects such as solar panels to a roof, which allows for use with multiple roof types, multiple solar module thicknesses, and flanged and flangeless solar module frames, the devices, assemblies, and methods are applicable for, but not limited to, implementation with regard to mounting any number of solar panels and/or any number of other components in a solar array, including but not limited to rails for mounting solar panels, in any conceivable position, and it is considered that there are various other configurations and uses for securely mounting components with the devices, assemblies, and methods of the present disclosure.

While several examples of devices, assemblies, and methods for mounting at least one object above a roof surface are shown in the accompanying figures and described in detail hereinabove, other aspects will be apparent to, and readily made by, those skilled in the art without departing from the scope and spirit of the disclosure. Accordingly, the foregoing description is intended to be illustrative rather than restrictive. The disclosure described hereinabove is defined by the appended claims and all changes to the disclosure that fall within the meaning and range of equivalency of the claims are to be embraced within their scope.

What is claimed is:

1. A roof mount, comprising:
a base installable on a roof;
an adjustment assembly operatively coupled to the base, the adjustment assembly comprising a partially threaded shaft extending along a first axis substantially perpendicular to the roof, an adjustment nut constrained within the adjustment assembly, and a support nut,
a clamp adjustably connected to the base by the adjustment assembly, wherein a distance between the clamp and the base is adjustable, the clamp comprising:
a first clamp portion that includes a central portion, a first support surface and a second support surface,
the first support surface comprising an angled first portion and a substantially horizontal second portion, the first support surface configured to support a portion of a first solar panel,
the central portion disposed between the first support surface and the second support surface; and
a second clamp portion; and
a fastener connected to the clamp, the fastener operable to tighten the second clamp portion to the first clamp portion.

2. The roof mount of claim 1, wherein the adjustment assembly is slidable on the base.

3. The roof mount of claim 2, further comprising a slider fastener configured to prevent the adjustment assembly from sliding relative to the base.

4. The roof mount of claim 1, wherein the base comprises a seal configured to engage the roof.

5. The roof mount of claim 4, wherein the seal comprises a polymeric material,
wherein a bottom surface of the polymeric material comprises a resin layer; and
wherein the seal is positioned on a bottom surface of the base.

6. The roof mount of claim 5, wherein an exposed portion of the resin layer is covered by a release sheet.

7. The roof mount of claim 1, wherein the central portion defines an aperture configured to receive the adjustment assembly.

8. The roof mount of claim 1, wherein the adjustment assembly comprises a pedestal operatively coupled to the base, the pedestal receives the partially threaded shaft, and the adjustment nut is constrained within the pedestal.

9. The roof mount of claim 8, wherein the pedestal comprises:
an upper member, a lower member and two or more side members defining an open space;
a first aperture through the upper member; and
a second aperture through the lower member,
wherein the first aperture and the second aperture are concentric with the first axis and configured to receive the partially threaded shaft.

10. The roof mount of claim 9, wherein the pedestal comprises a first ledge and a second ledge, and
wherein the upper member, the first ledge and the second ledge are configured to vertically constrain the adjustment nut within the pedestal.

11. The roof mount of claim 10, wherein the two or more side members and the partially threaded shaft are configured to horizontally constrain the adjustment nut within the pedestal.

12. The roof mount of claim 11, wherein the adjustment nut is rotationally constrained within the pedestal.

13. The roof mount of claim 12, wherein the two or more side members are configured to rotationally constrain the adjustment nut within the pedestal, such that the two or more side members prevent rotation of the adjustment nut.

14. The roof mount of claim 10, wherein the pedestal comprises a first catch extending from the lower member and a first side member of the two or more side members; and
a second catch extending from the lower member and a second side member of the two or more side members,
wherein the first catch and the second catch are slidably engaged with the base.

15. The roof mount of claim 14, wherein the pedestal comprises a pedestal arm extending from the second catch, the pedestal arm comprising an aperture configured to receive a slider fastener configured to prevent the adjustment assembly from sliding relative to the base.

16. The roof mount of claim 1, wherein the support nut is coupled to the partially threaded shaft below a non-threaded portion of the partially threaded shaft such that the support nut is configured to rotate with the partially threaded shaft, and wherein the support nut is configured to contact and support the central portion such that the clamp is supported above the adjustment assembly.

17. The roof mount of claim 1, wherein a top of the first clamp portion is contacted by a drive head of the partially threaded shaft such that the partially threaded shaft and the support nut are configured to rotate with respect to the adjustment nut and independently of the first clamp portion.

18. The roof mount of claim 1, wherein the second support surface is configured to support a portion of a second solar panel.

19. The roof mount of claim 1, wherein the second support surface is configured to support a portion of a skirt.

20. The roof mount of claim 1, further comprising an access defined through the second clamp portion, and
a second fastener connected to the clamp, the second fastener operable to tighten the second clamp portion to the first clamp portion.

21. The roof mount of claim 20, wherein the access is defined between the first fastener and the second fastener, and
wherein the first fastener and second fastener are positioned at opposite ends of the clamp.

22. The roof mount of claim 20, further comprising a flashing member, the base installable to the roof over the flashing member.

23. The roof mount of claim 1, further comprising a flashing member, the base installable to the roof over the flashing member.
